(19) United States
(12) Patent Application Publication
(10) Pub. No.: US 2026/0343503 A1
(43) Pub. Date: Oct. 29, 2026

(54) METHOD PERFORMED BY ACCESS NETWORK NODE, METHOD PERFORMED BY USER EQUIPMENT (UE), ACCESS NETWORK NODE, UE

(71) Applicant: NEC CORPORATION, Minato-ku, Tokyo (JP)

(72) Inventors: Ayesha IJAZ, Minato-ku, Tokyo (JP); Pravjyot DEOGUN, Milton Keynes (GB)

(73) Assignee: NEC CORPORATION, Minato-ku, Tokyo (JP)

(21) Appl. No.: 19/114,520

(22) PCT Filed: Oct. 3, 2023
(86) PCT No.: PCT/JP2023/036122

§ 371 Date: Mar. 24, 2025

(30) Foreign Application Priority Data
Oct. 7, 2022 (GB) 2214820.9

(51) Int. Cl. H04W 72/0453; H04L 5/00

(52) U.S. Cl. CPC H04W 72/0453; H04L 5/0053

(57) ABSTRACT

An access network node is disclosed that transmits first information for configuring time domain resources with a downlink (DL) frequency region and an uplink (UL) frequency region. The access network node communicates with a UE in the time domain resources in a manner that avoids overlap between a UL frequency region and resources for DL communication or a DL frequency region and resources for UL communication.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods that support full duplex communication in time division duplex (TDD) communication bands.

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

In the current 5G architecture, for example, the gNB structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), PDCP and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each gNB.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

Historically, communication systems have employed two core duplex schemes-frequency division duplex (FDD) and time division duplex (TDD). In FDD the frequency domain resource is split between downlink (DL) and uplink (UL) whereas in TDD the time domain resource is split between DL and UL.

time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

### CITATION LIST

### Patent Literature

PTL 1: US2021/0391963A1

PTL 2: US2021/0400654A1

### Non Patent Literature

NPL 1: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

However, allocation of too limited a time duration for the UL in TDD carriers has the potential to result in reduced coverage, increased latency, and reduced capacity.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at the gNB, within TDD carriers, are currently being developed-currently with no restriction on the possible frequency ranges used for such FD operation. At present half duplex operation within TDD carriers is still envisaged for the UE, although full duplex UE operation remains an option for the future. The use of FD has, however, the potential to cause serious interference issues, both at the base station and at the UE, which are difficult to address.

There are a number of possible FD implementations that can be implemented on TDD carriers including, for example, subband non-overlapping, subband overlapping, full overlapping.

Referring to FIGS. 1 to 4, in subband non-overlapping FD (′SBFD′, also referred to as cross division duplex (XDD)), non-overlapping UL and DL subbands may be configured in the TDD carrier (as seen in the general case illustrated in FIG. 1. As seen in FIGS. 1 to 4 each subband comprises a respective relatively ‘narrow’ frequency band having a bandwidth that extends only part of the full available bandwidth within the current TDD carrier that is configured for communication in the associated cell. A base station can thus perform simultaneous (full duplex) transmission and reception at the same time, in different respective non-overlapping subbands, for different UEs.

FIG. 2 shows a particular example in which only one dedicated DL subband and one dedicated UL subband are configured in the TDD carrier. FIG. 3 shows an example in which, from the first slot to the fourth slot, full duplex operation is active where an UL subband is present in the centre of the frequency band and two DL subbands are present at either side of the DL subband. In the fifth slot, the base station uses legacy TDD operation (i.e. entire frequency band is used only for UL). FIG. 4 shows an example in which, from the first slot to the fifth slot, full duplex operation is active. In the first four slots an UL subband is present in the centre of the frequency band and two DL subbands are present at either side of the DL subband. In the fifth slot a complementary UL/DL configuration is present compared to the first four slots.

In subband overlapping FD, UL and DL may be configured in a similar way to subband non-overlapping FD, but the different subbands are allowed to overlap in frequency.

In full overlapping FD, the entire available bandwidth may be used for UL or DL transmissions.

One of the key benefits of SBFD is increased UL coverage because SBFD makes it easier to take advantage of multi-slot UL repetitions due to an increased number of consecutive UL occasions in SBFD. Currently, therefore, focus is on the development of techniques for implementing subband non-overlapping FD operation and potential related enhancements for dynamic or flexible TDD. It will be appreciated, however, that other FD implementations remain an option for the future and enhancements envisaged for sub-band non-overlapping FD may have benefits in other FD schemes.

When implementing such full duplex schemes there are a number of considerations that need to be taken into account. Among the considerations that are particularly relevant for SBFD (and other full duplex schemes), for example, is the need to avoid, or at least minimise, any impact on the operation of existing (‘legacy’) UEs that were designed/implemented prior to the implementation of any such duplex schemes. Moreover, the impact of full duplex on other procedures such as search space configuration, resource allocation for DL and UL channels, and UL/DL transmission procedures (e.g., multi-slot transmission) need to be considered.

### Solution to Problem

The disclosure aims to provide apparatus and methods that at least partially address the above needs and/or issues.

In one aspect the disclosure provides a method performed by an access network node, the method comprising:
transmitting, to a user equipment (UE), first information for configuring at least one time domain resource with at least two frequency regions, wherein the at least two frequency regions include at least one downlink (DL) frequency region for DL communication and at least one uplink (UL) frequency region for UL communication; and
communicating with the UE, in the at least one time domain resource with at least two frequency regions, based on second information,
wherein the second information indicates at least one of:
at least one search space set;
at least one frequency resource set scheduled for DL communication to the UE;
at least one control resource set (CORESET); or
at least one frequency resource set scheduled for UL communication from the UE; and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the UE; or
between the at least one DL frequency region and the at least one frequency resource set scheduled for UL communication from the UE.

In one aspect the disclosure provides a method performed by a user equipment (UE), the method comprising:
receiving, from an access network node, first information for configuring at least one time domain resource with at least two frequency regions, wherein the at least two frequency regions include at least one downlink (DL) frequency region for DL communication and at least one uplink (UL) frequency region for UL communication;
communicating with the access network node, in the at least one time domain resource with at least two frequency regions, based on second information, wherein the second information is adapted to configure at least one of:
at least one search space set; at least one frequency resource set scheduled for DL communication from the access network node;
at least one control resource set (CORESET); or
at least one frequency resource set scheduled for UL communication to the access network node; and
determining, based on at least one of the first information and the second information, at least one set of resources for at least one of:
monitoring the at least one search space set; DL communication in the at least one frequency resource set scheduled for DL communication;
monitoring the at least one CORESET; or
UL communication in the at least one frequency resource set scheduled for UL communication;
wherein, the at least one set of resources is determined by the UE to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

In one aspect the disclosure provides an access network node comprising:
means for transmitting, to a user equipment (UE), first information for configuring at least one time domain resource with at least two frequency regions, wherein the at least two frequency regions include at least one downlink (DL) frequency region for DL communication and at least one uplink (UL) frequency region for UL communication; and
means for communicating with the UE, in the at least one time domain resource with at least two frequency regions, based on second information,
wherein the second information is adapted to configure at least one of:
at least one search space set;
at least one frequency resource set scheduled for DL communication to the UE;
at least one control resource set (CORESET); or
at least one frequency resource set scheduled for UL communication from the UE; and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the UE; or
between the at least one DL frequency region and the at least one frequency resource set scheduled for UL communication from the UE.

In one aspect the disclosure provides a user equipment (UE) comprising:
means for receiving, from an access network node, first information for configuring at least one time domain resource with at least two frequency regions, wherein the at least two frequency regions include at least one downlink (DL) frequency region for DL communication and at least one uplink (UL) frequency region for UL communication;
means for communicating with the access network node, in the at least one time domain resource with at least two frequency regions, based on second information,
wherein the second information is adapted to configure at least one of:
at least one search space set;
at least one frequency resource set scheduled for DL communication from the access network node;
at least one control resource set (CORESET); or
at least one frequency resource set scheduled for UL communication to the access network node; and
means for determining, based on at least one of the first information and the second information, at least one set of resources for at least one of:
monitoring the at least one search space set;
DL communication in the at least one frequency resource set scheduled for DL communication;
monitoring the at least one CORESET; or
UL communication in the at least one frequency resource set scheduled for UL communication;
wherein, the at least one set of resources is determined by the UE to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

### Advantageous Effects of Invention

According to the present disclosure, a method performed by an access network node, a method performed by a UE, an access network node, and a UE are provided.

### BRIEF DESCRIPTION OF DRAWINGS

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting of its scope, for the subject matter may admit to other equally effective embodiments.

Example embodiments of the disclosure will now be described, by way of example, with reference to the accompanying drawings in which:

FIG. 1 is simplified time frequency diagrams illustrating a subband non-overlapping full duplex scheme and various exemplary implementations of such a scheme;

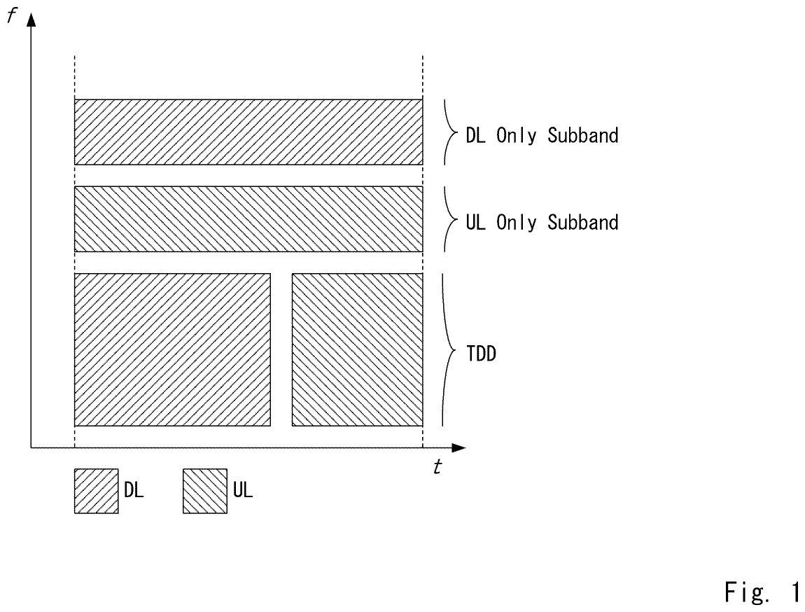

FIG. 2 is simplified time frequency diagrams illustrating a subband non-overlapping full duplex scheme and various exemplary implementations of such a scheme;

FIG. 3 is simplified time frequency diagrams illustrating a subband non-overlapping full duplex scheme and various exemplary implementations of such a scheme;

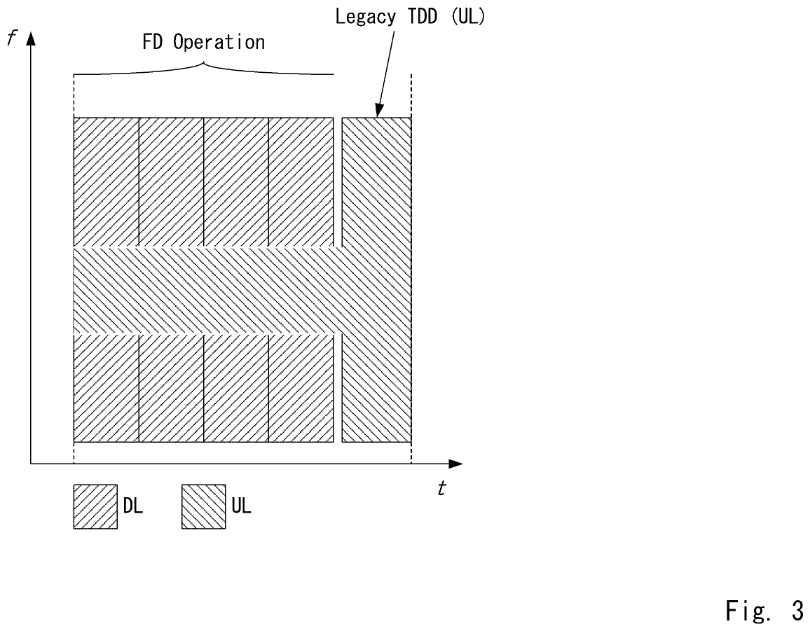

FIG. 4 is simplified time frequency diagrams illustrating a subband non-overlapping full duplex scheme and various exemplary implementations of such a scheme;

FIG. 5 schematically illustrates a mobile (‘cellular’ or ‘wireless’) telecommunication system;

FIG. 6 illustrates a typical frame structure that may be used in the telecommunication system of FIG. 5;

FIG. 7 is a simplified sequence diagram illustrating different slot configuration procedures that can be employed in the telecommunication system of FIG. 5;

FIG. 8 shows illustrative examples of slot configurations configured by the procedures of FIG. 7;

FIG. 9 is a simplified time frequency diagram showing illustrative examples of a non-interleaved CORESET design that may be used in the telecommunication system of FIG. 5;

FIG. 10 is a simplified time frequency diagram showing an illustrative example of a full duplex configuration that may be used in the telecommunication system of FIG. 5;

FIG. 11 is a simplified time frequency diagram showing an illustrative example of another full duplex configuration that may be used in the telecommunication system of FIG. 5;

FIG. 12 is simplified time frequency diagram showing an illustrative example of another full duplex configuration that may be used in the telecommunication system of FIG. 5;

FIG. 13 is a simplified sequence diagram illustrating a number of procedures for CSS configuration that may be employed in the in the telecommunication system of FIG. 5;

FIG. 14 is a simplified time frequency diagram showing an illustrative example of a CSS configuration that may configured by a procedure illustrated in FIG. 13;

FIG. 15 is a simplified time frequency diagram showing an illustrative example of another CSS configuration that may configured by a procedure illustrated in FIG. 13;

FIG. 16 is a simplified sequence diagram illustrating another procedure for CSS configuration that may be employed in the in the telecommunication system of FIG. 5;

FIG. 17 is a simplified time frequency diagram showing an illustrative example of another CSS configuration that may configured by the procedure illustrated in FIG. 16;

FIG. 18 is a simplified sequence diagram illustrating a number of procedures for CORESET resource allocation that may be employed in the in the telecommunication system of FIG. 5;

FIG. 19 is a simplified sequence diagram illustrating another procedure for CORESET resource allocation that may be employed in the in the telecommunication system of FIG. 5;

FIG. 20 is a simplified time frequency diagrams showing illustrative examples of the use of two different CORESET configurations that may be configured by the procedure illustrated in FIG. 19;

FIG. 21 is a simplified time frequency diagrams showing illustrative examples of the use of two different CORESET configurations that may be configured by the procedure illustrated in FIG. 19;

FIG. 22 is a simplified time frequency diagrams showing illustrative examples of the use of two different CORESET configurations that may be configured by the procedure illustrated in FIG. 19;

FIG. 23 is a simplified time frequency diagrams showing illustrative examples of the use of two different CORESET configurations that may be configured by the procedure illustrated in FIG. 19;

FIG. 24 is a simplified sequence diagram illustrating a procedure for resource configuration for an interleaving and/or frequency hopping that may be employed in the in the telecommunication system of FIG. 5;

FIG. 25 is a simplified sequence diagram illustrating another procedure for resource configuration for an interleaving and/or frequency hopping that may be employed in the in the telecommunication system of FIG. 5;

FIG. 26 is a simplified sequence diagram illustrating another procedure for resource configuration for an interleaving and/or frequency hopping that may be employed in the in the telecommunication system of FIG. 5;

FIG. 27 is a simplified sequence diagram illustrating a procedure for multi-slot UL/DL transmission that may be employed in the in the telecommunication system of FIG. 5;

FIG. 28 is a simplified time frequency diagram showing an illustrative example of an application of the procedure of FIG. 27;

FIG. 29 is a simplified sequence diagram illustrating another procedure for multi-slot UL/DL transmission that may be employed in the in the telecommunication system of FIG. 5;

FIG. 30 is a simplified time frequency diagram showing an illustrative example of an application of the procedure of FIG. 29;

FIG. 31 is a simplified sequence diagram illustrating another procedure for multi-slot UL/DL transmission that may be employed in the in the telecommunication system of FIG. 5;

FIG. 32 is a simplified time frequency diagram showing an illustrative example of an application of the procedure of FIG. 31;

FIG. 33 is a simplified sequence diagram illustrating another procedure for multi-slot UL/DL transmission that may be employed in the in the telecommunication system of FIG. 5;

FIG. 34 is a simplified time frequency diagram showing an illustrative example of an application of the procedure of FIG. 23;

FIG. 35 is a schematic block diagram illustrating the main components of a UE for the telecommunication system of FIG. 5; and

FIG. 36 is a schematic block diagram illustrating the main components of a base station for the telecommunication system of FIG. 5.

### DESCRIPTION OF EXAMPLE EMBODIMENTS

### Overview

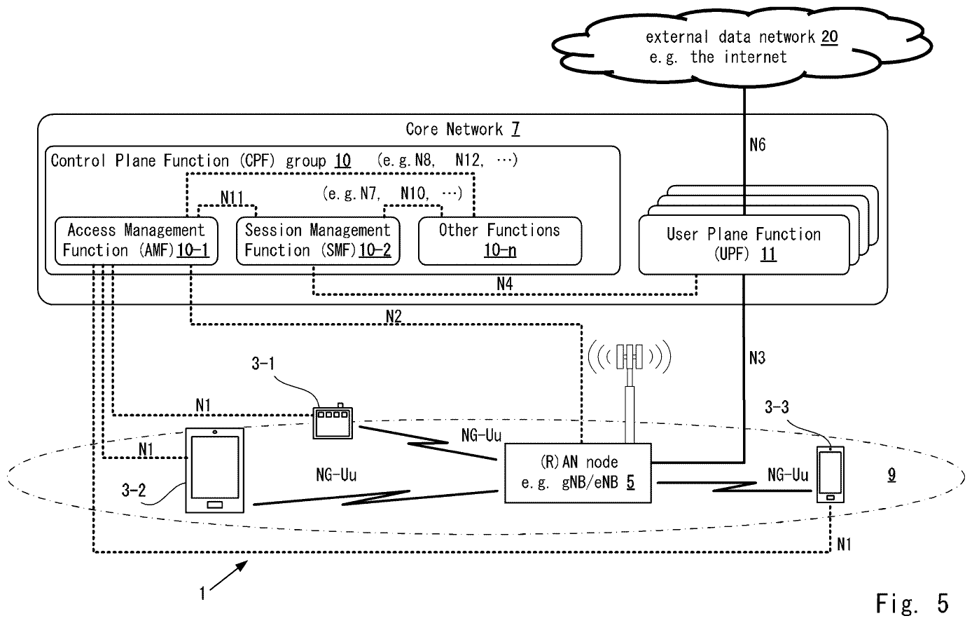

An exemplary telecommunication system will now be described in general terms, by way of example only, with reference to FIGS. 5 to 12.

FIG. 5 schematically illustrates a mobile (‘cellular’ or ‘wireless’) telecommunication system 1 to which example embodiments of the present disclosure is applicable.

In the telecommunication system 1 user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network (5GC) or evolved packet core network (EPC)).

As those skilled in the art will appreciate, whilst three UEs 3 and one base station 5 are shown in FIG. 5 for illustration purposes, the system, when implemented, will typically include other base stations and UEs.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network 20 (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the telecommunication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block (MIB). It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

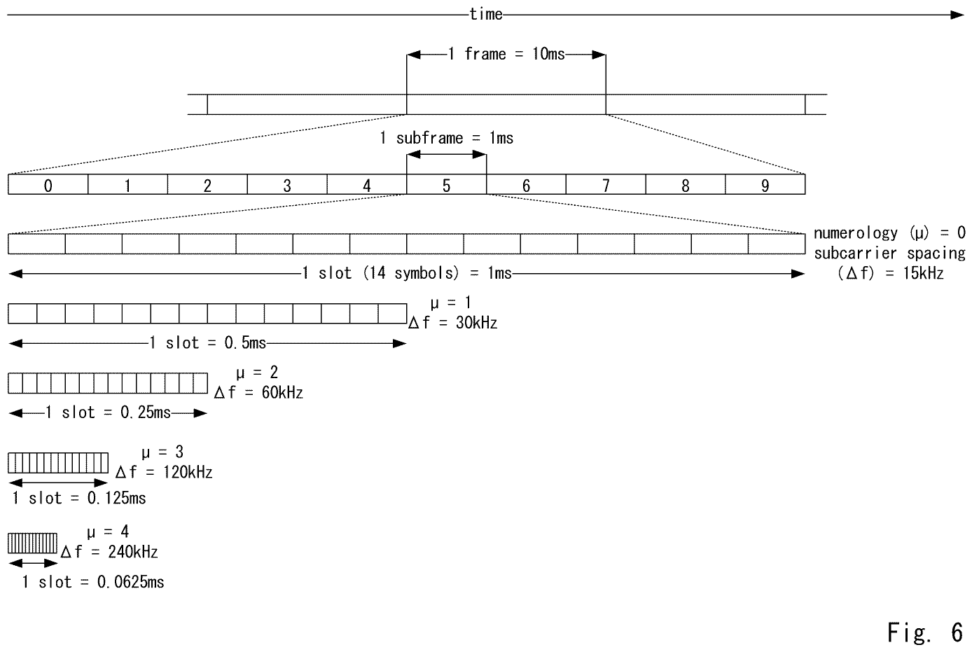

Referring to FIG. 6, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 6, the telecommunication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2μ kHz). The relationship between the parameter, μ, and SCS (Δf) is as shown in Table 1:

TABLE 1
1-5G numerology

| | | Number of | Slot |
|---|---|---|---|
| | | slots per | length |
| μ | Δf = 2^{μ} · 15[kHz] | subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### <General Slot Configuration>

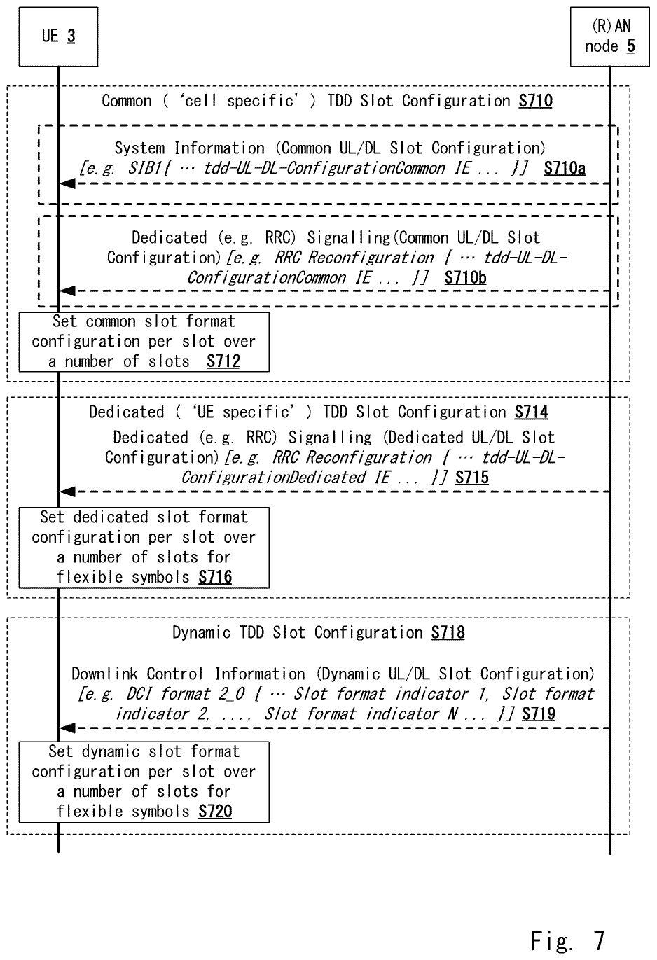

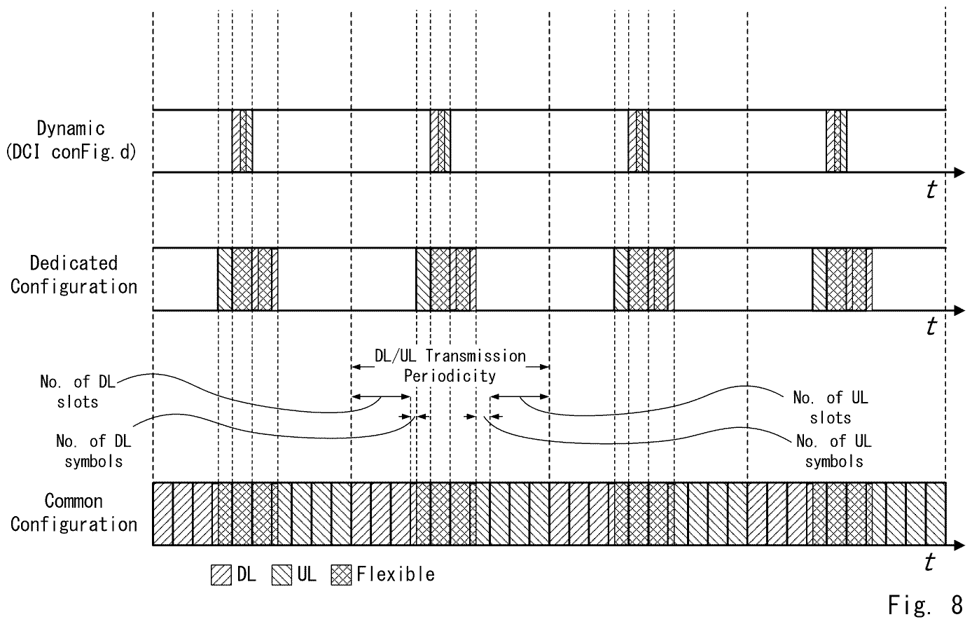

Referring to FIGS. 7 and 8 the base station 5 configures the slot usage within each cell 9 operated on a TDD carrier appropriately.

As seen in FIG. 7, which is a simplified sequence diagram illustrating different slot configuration procedures (S710, S714, S718) that can be employed in the telecommunication system 1, the base station 5 is capable of employing a number of different procedures for configuring slot usage in each cell 9 operated on the TDD carrier.

As seen in procedure S710, for example, the base station 5 of the telecommunication system 1 is configured for providing a respective common (or ‘cell specific’) slot configuration, for each cell 9 operated on a TDD carrier. This common slot configuration can be provided using system information (as illustrated at S710a) to all UEs 3 within the cell (for example in a tdd-UL-DL-ConfigurationCommon information element (IE) of system information block type 1 (SIB1)). This common slot configuration can also be provided using dedicated (e.g., radio resource control (RRC)) signalling (as illustrated at S710b) to specific UEs 3 within the cell (for example in a tdd-UL-DL-ConfigurationCommon IE of an RRC message such as an RRC reconfiguration message or the like). On receipt of the common slot configuration a UE 3 can thus set a common slot format configuration per slot over a number of slots (as seen at S712).

As seen in FIG. 8, which shows illustrative examples of slot configurations configured by the procedures of FIG. 7, the slots may be configured as downlink only slots, as uplink only slots, or as unallocated or ‘flexible’ slots (that may be downlink or uplink).

The common slot configuration is defined by a number of parameters provided by the base station 5 as part of the common UL/DL configuration. These parameters include: a slot configuration period (e.g., configured by a dl-UL-TransmissionPeriodicity IE); a number of slots with only downlink symbols (e.g., configured by a nrofDownlinkSlots IE); a number of downlink symbols (e.g., configured by a nrofDownlinkSymbols IE); a number of slots with only uplink symbols (e.g., configured by a nrofUplinkSlots IE); and a number of uplink symbols (e.g., configured by a nrofUplinkSymbols IE). As seen in FIG. 8, these effectively configure a repeating pattern of slot types (repeating at the slot configuration period), which in this example comprises DL only slots and symbols, followed by flexible slots and symbols, followed by UL only slots and symbols. The repeating pattern starts with a DL group comprising the defined number of DL only slots followed by the defined number of DL only symbols in the next slot. The repeating pattern ends with a UL group comprising the defined number of UL only slots preceded by the defined number of UL only symbols in the preceding slot. The flexible symbols and slots are those, between the DL group of DL only slots and symbols and the UL group of UL only slots and symbols.

As seen in procedure S714, the base station 5 of the telecommunication system 1 is also configured for providing, if required, a dedicated (or ‘UE specific’) slot configuration for a specific UE 3. This dedicated slot configuration can be provided using dedicated (e.g., radio resource control (RRC)) signalling (as illustrated at S715) to a specific UE 3 within the cell (for example in a tdd-UL-DL-ConfigurationDedicated IE of an RRC message such as an RRC reconfiguration message or the like).

If a UE 3 is provided with the dedicated slot configuration in addition to the common slot configuration, then the dedicated slot configuration overrides only the symbols and slots configured as flexible symbols and slots, per slot, over the number of slots configured by the common slot configuration (as seen in the example of FIG. 8).

The dedicated configuration, if provided, includes one or more individual slot specific configurations (e.g., using a slotSpecificConfigurationsToAddModList IE) in which each slot configuration contains information (e.g., a slotindex IE) identifying a specific slot within the slot configuration period defined by the common slot configuration, and information defining a symbol structure (e.g., a symbols IE). The information defining the symbol structure provides the direction (downlink or uplink) for the symbols within the specific slot that is being configured. The information defining the symbols structure may, for example: indicate that all symbols in the specific slot are used for the downlink (e.g., by setting the symbols IE to ‘allDownlink’); indicate that all symbols in the specific slot are used for the uplink (e.g., by setting the symbols IE to ‘allUplink’); or explicitly indicate how many symbols at the beginning and the end of the specific slot are allocated to downlink and uplink, respectively (e.g., a nrofDownlinkSymbols IE may indicate the number of consecutive downlink symbols in the beginning of the slot identified by the slot index, and a nrofUplinkSymbols IE may indicate the number of consecutive uplink symbols at the end of the slot identified by the slot index).

A UE 3 can thus set a dedicated slot format configuration per slot over a number of slots (as seen at S716).

A UE 3 thus teats symbols in a slot indicated as downlink by the common slot configuration, or the dedicated slot configuration to be available for receptions. Similarly a UE 3 teats symbols in a slot indicated as uplink by the common slot configuration, or the dedicated slot configuration to be available for transmissions.

Even after the slot configurations in a cell-specific and UE-specific manner described above, the slot configuration may have some more flexible slots/symbols left unallocated. By making use of layer 1 signalling, the remaining (if any) flexible symbols can dynamically be reconfigured.

As seen in procedure S718, for example, the base station 5 of the telecommunication system 1 is also configured for providing one or more dynamic slot configurations to a group of one or more UEs 3 by means of a physical downlink control channel (PDCCH). One or more dynamic slot configurations can be provided using downlink control information (DCI) using an appropriate DCI format (e.g., DCI format 2_0), as illustrated at S719, to a specific group of one or more UEs 3 within the cell 9.

Indexes of one or more slot format indicators (SFIs) are provided within the payload of the DCI for the group of one or more UEs 3. To allow the DCI to be addressed to and decoded by one or more UEs 3 of the group, cyclic redundancy check (CRC) bits of the DCI are scrambled with an associated radio network temporary identifier (RNTI), for example a slot format indicator RNTI (′SFI-RNTI′) or the like. One or more UEs in the group are allocated with the same RNTI. Each UE 3 of the group is configured to extract its own SFI-index based on the position of the SFI-index within the DCI payload (this position may, for example, be configured by UE specific RRC signalling). The RRC configuration may, for example, be by means of an RRC message carrying a PDCCH serving cell configuration IE having a slot format indicator (SFI) IE that, for a specific serving cell (identified by a serving cell ID (e.g., by a servingCellId IE)): provides an SFI-RNTI; defines one or more slot format combinations (e.g., by a slotFormatCombinations IE); and specifies the starting position (bit), in the DCI, of the SFI index that is applicable for the configured UE (e.g., by a positionInDCI IE).

Each SFI-index provided by the DCI acts as a pointer to a combination of slot formats (where each slot format corresponds to a respective combination of downlink, uplink, and/or flexible symbols) for defining a slot format for each slot in a number of slots starting from a slot where the UE detects the dynamic slot configuration DCI format.

Thus, for any slot indicated to a UE 3 as flexible by both a common slot configuration and a dedicated slot configuration, the DCI can be used to dynamically configure downlink, uplink, and/or flexible symbols within that slot (as seen in the example of FIG. 8).

A UE 3 can thus set a dynamic slot format configuration per slot over a number of slots (as seen at S720).

### <Bandwidth Parts (BWPs)>

In the telecommunication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and base station 5 of the telecommunication system 1 are thus configured for operation using BWPs. For each serving cell of a UE 3, the base station 5 can configure at least one downlink (DL) BWP (e.g. an initial DL BWP). The base station 5 may configure the UE 3 with up to a maximum (typically four) DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g. an initial UL BWP). The base station 5 may configure the UE 3 with up to a maximum (typically four) UL BWPs with only one UL BWP being active at a given time. The UE 3 does not transmit PUSCH or PUCCH outside an active bandwidth part. For an active cell, the UE 3 does not transmit SRS outside an active bandwidth part. It will be appreciated that the slot format indicator (e.g., an SFI-index field value) in the dynamic slot configuration DCI format may indicate to a UE 3 a slot format for each slot in a number of slots for each DL BWP or each UL BWP.

A BWP identifier or index (BWP-ID) is used to refer to BWPs (in UL and DL independently). Various radio resource control (RRC) configuration procedures can thus use the BWP-ID to associate themselves with a particular BWP.

While for paired spectrum (FDD), DL BWPs and UL BWPs are configured separately, for unpaired spectrum (TDD), a DL BWP is effectively linked to (paired with) a UL BWP, with the paired DL BWP and UL BWP sharing the same BWP-ID and centre frequency (but possibly different bandwidths).

Specifically, the base station 5 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig IE within an RRC message that contains a dedicated, UE-specific, BWP configuration). The dedicated signalling may also contain some cell-specific information which may be useful for specific scenarios (e.g. handover).

The base station 5 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for one or more initial UL BWPs may be provided via system information whereas UE specific parameters may be provided via dedicated signalling (e.g. in a ServingCellConfig IE within an RRC message that contains a dedicated, UE-specific, BWP configuration). This provides configuration information either for a so-called special cell (SpCell)—which is a primary cell (PCell) of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a PDCCH for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The base station 5 configures the frequency domain location and bandwidth of the initial DL BWP in the system information so that the initial DL BWP contains the entire CORESET #0 in the frequency domain.

For each DL BWP in a set of DL BWPs for a primary cell (PCell), a UE 3 can be configured with CORESETs for every type of common search space (CSS) set (sometimes referred to as a cell-specific search space (CSS)) and for a UE-specific search space (USS) set. For each UL BWP in a set of UL BWPs of a PCell, or of a PUCCH-secondary cell, the UE 3 is configured resource sets for PUCCH transmissions.

The UE 3 is configured for switching its active BWP between its configured BWPs when required. For example, switching at the UE 3 may be initiated by receipt of a scheduling DCI, by expiry of an inactivity timer (e.g., a BWPInactivityTimer), and/or by initiation of a random-access procedure.

### <PDCCH Configuration>

Each UE 3 is configured to monitor a set of PDCCH candidates in one or more CORESETs on the currently active DL BWP according to corresponding search space sets. This monitoring involves decoding each PDCCH candidate according to corresponding monitored DCI formats.

Each set of PDCCH candidates for a UE 3 to monitor is defined in terms of PDCCH search space sets, where a search space set may be a CSS set or a USS set as described above. For example, a given UE 3 may monitor PDCCH candidates in one or more of the following search spaces sets:
a PDCCH CSS set related to transmission of a PDCCH for a system information (SI) message (e.g., SIB1 carrying remaining minimum system information (‘RMSI’)). Such a CSS may be referred to as a Type 0 PDCCH CSS and may be configured by an appropriate search space configuration IE for a DCI format with a CRC scrambled by a system information RNTI (SI-RNTI) on a PCell (e.g., in a so-called ‘pdcch-ConfigSIBI’ IE provided in the MIB, or in a so-called ‘searchSpaceSIBI’ or ‘searchSpaceZero’ in a ‘PDCCH-ConfigCommon’ IE of an appropriate RRC message);
a PDCCH CSS set related to transmission of a PDCCH for other system information (e.g., carried by other SIBs). Such a CSS may be referred to as a Type 0A PDCCH CSS set and may be configured by an appropriate search space configuration IE for a DCI format with CRC scrambled by a SI-RNTI on a PCell (e.g., in a so-called ‘searchSpaceOtherSystemInformation’ IE provided in a ‘PDCCH-ConfigCommon’ IE of an appropriate RRC message);
a PDCCH CSS set related to a random-access procedure. Such a CSS may be referred to as a Type 1 PDCCH CSS set and may be configured by an appropriate search space configuration IE for a DCI format with CRC scrambled by an appropriate RNTI on a PCell (e.g., random access RNTI (RA-RNTI), a random-access response message (RAR/MsgB) RNTI (MsgB-RNTI), or a temporary cell RNTI (TC-RNTI). The search space configuration IE may, for example, be a so-called ‘ra-SearchSpace’ IE provided in a ‘PDCCH-ConfigCommon’ IE of an appropriate RRC message;
a PDCCH CSS set related to paging. Such a CSS may be referred to as a Type 2 PDCCH CSS set and may be configured by an appropriate search space configuration IE for a DCI format with CRC scrambled by an appropriate RNTI on a PCell (e.g., paging RNTI (P-RNTI)). The search space configuration IE may, for example, be a so-called ‘pagingSearchSpace’ IE provided in a ‘PDCCH-ConfigCommon’ IE of appropriate RRC message;
a PDCCH CSS set related to other procedures (such as scheduling, power control etc.). Such a CSS may be referred to as a Type 3 PDCCH CSS set and may be configured by an appropriate search space configuration IE for a DCI format with CRC scrambled by an appropriate RNTI on an SCell or PCell. The RNTI may, for example, be an interruption RNTI (INT-RNTI), an SFI-RNTI, a PUSCH power control RNTI (TPC-PUSCH-RNTI), a PUCCH power control RNTI (TPC-PUCCH-RNTI), an SRS trigger and power control RNTI (TPC-SRS-RNTI), a cancellation indication RNTI (CI-RNTI), a cell RNTI (C-RNTI), a modulation and coding scheme cell RNTI (MCS-C-RNTI), one or more configured scheduling CS-RNTIs, or a power saving RNTI (PS-RNTI). The search space configuration IE may, for example, be a so-called ‘SearchSpace’ IE provided in a ‘PDCCH-Config’ IE of appropriate RRC message;
a USS set for DCI formats with CRC scrambled by an appropriate RNTI. The RNTI may, for example, be a C-RNTI, an MCS-C-RNTI, a semi-persistent (SP) channel state information (CSI) RNTI (SP-CSI-RNTI), and or one or more CS-RNTIs. The search space configuration IE may, for example, be a so-called ‘SearchSpace’ IE provided in a ‘PDCCH-Config’ IE of appropriate RRC message.

For each search space set, the UE 3 is provided with information for configuring: an association between the search space set and a CORESET; a PDCCH monitoring periodicity and a PDCCH monitoring offset; a PDCCH monitoring pattern within a slot; an indication that search space set is either a CSS set or a USS as appropriate; and/or one or more DCI formats to monitor.

It will be appreciated that CSS sets are expected to be used by both older ‘legacy’ UEs that are not configured for SBFD communication, and more modern UEs that are configured to support SBFD communication, at least for monitoring broadcast channels.

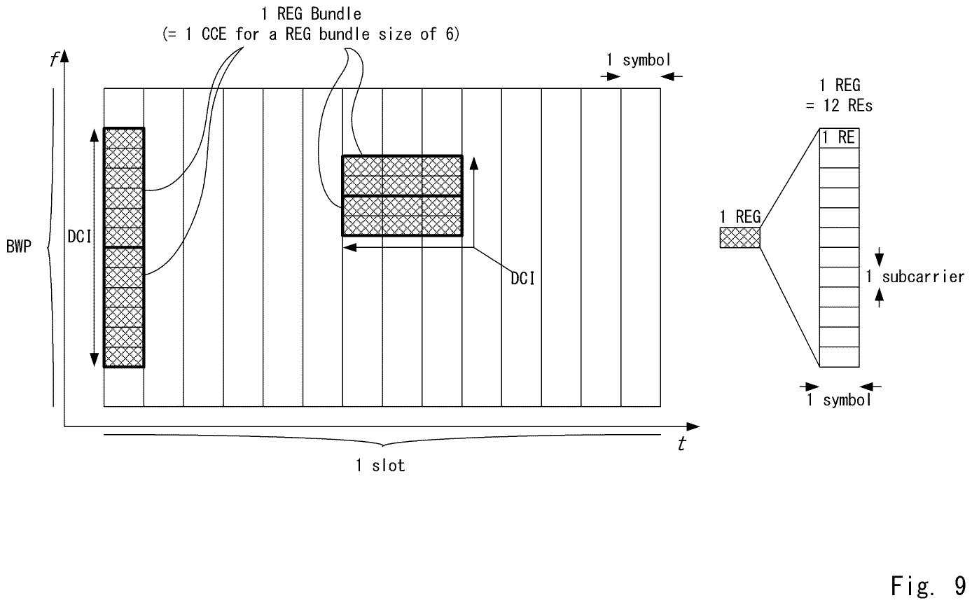

The way in which CORESETs may be configured will now be described in more detail with reference to FIG. 9, which is a simplified time frequency diagram showing illustrative examples of a non-interleaved CORESET design.

Each CORESET may be described in terms of resource groupings at different levels of granularity as follows:
A resource element (RE), which is the smallest unit within the 5G NR resource grid and consists of one subcarrier in the frequency domain and one symbol in time domain;
A resource element group (REG), which comprises a single RB in the frequency domain (where each RB comprises 12 subcarriers/REs in the frequency domain) and one symbol in the time domain;
A REG bundle, which comprises multiple REGs. The bundle size is (in number of REGs) is variable (typically specified by a parameter indicated in RRC signalling using an appropriate IE (e.g. ‘reg-bundle-size’));
A control channel element (CCE), which comprises a number of REGs (six in current 5G systems but hypothetically variable) in units of one or more REG bundles (depending on REG bundle size); and
An aggregation level, which indicates the number CCEs allocated for a PDCCH.

Currently NR supports both distributed and localised resource allocation for a DCI in a CORESET. Distributed resource allocation for a DCI may be achieved by configuring an interleaved CCE-to-REG mapping for each CORESET whereas localised resource allocation (as illustrated in FIG. 9) for a DCI may be achieved by configuring a non-interleaved CCE-to-REG mapping for each CORESET.

For non-interleaved CCE-to-REG mapping, all CCEs for a DCI with a given aggregation level L are mapped to consecutive REG bundles of the CORESET. For interleaved CCE-to-REG mapping, REG bundles constituting the CCEs for a PDCCH are distributed in the frequency domain in units of REG bundles. To support this, block interleaving is used where the interleaving spans across all REGs present in the CORESET.

A given DCI having a specific aggregation level, L, may therefore comprise L continuously numbered CCEs in which the CCEs are mapped on to a number of REGs (which may be grouped in non-contiguous REG bundles in the case of interleaving) in a given CORESET.

As explained above, a serving cell can have up to four BWPs. Each of these BWPs can currently have up to three CORESETs. The base station 5 provides the UE 3 with information for configuring one or more CORESETs.

This configuration information typically includes, for example, information for identifying a number of consecutive symbols (e.g., 1, 2, or 3) representing a duration of the CORESET. The configuration information also typically includes information identifying a set of frequency domain resources (e.g., a set of RBs)—for example, in the form of an appropriate frequency domain resources IE (e.g., a frequencyDomainResources IE) defining the resources. The frequency domain resources IE may, for example be in the form of a bitmap, or the like, in which each bit corresponds a group of frequency resources (e.g., a group of six RBs) in which the grouping starts from an initial physical frequency resource (e.g., physical RB (PRB 0) that is fully contained in the BWP within which the corresponding CORESET is configured. It will be appreciated that the term PRB generally refers to RBs that are indexed in frequency order in the frequency domain. This contrasts with virtual RBs (VRBs) which, when arranged in numerical order, may (but does not have to) correspond to physical frequency resources (subcarriers, PRBs, groups thereof, or the like) that are not arranged in frequency order.

The configuration information also typically comprises CCE-to-REG mapping information for use in identifying the resources forming each CCE and hence each PDCCH candidate. The CCE-to-REG mapping information typically includes information defining the REG bundle size (e.g., ‘reg-bundle-size’) and, where interleaving is used, information identifying an interleaver size and potentially a shift index (which may be a physical cell identity).

The configuration information defining a CORESET is typically provided using RRC signalling. However, the CORESET having index 0 (CORESET #0) is a special CORESET that is configured using a four-bit information element in the MIB.

An example of an interleaved CCE-to-Reg bundle mapping is illustrated in Table 2 below. The mapping shown is for a 48 PRB CORESET in which the PRBs are indexed consecutively (from 0 to 47) in the frequency domain. The REG bundle size is 6 REGs (PRBs), the duration of the CORESET is 1 symbol in the time domain, the interleaver size is 2, and the shift index is 160.

TABLE 2

| | REG Bundle | Indices of REGs |
|---|---|---|
| CCE(j) | Index | (PRBs) in bundle |
| 0 | 0 | 0, 1, 2, 3, 4, 5 |
| 1 | 4 | 24, 25, 26, 27, 28, 29 |
| 2 | 1 | 6, 7, 8, 9, 10, 11 |
| 3 | 5 | 30, 31, 32, 33, 34, 35 |
| 4 | 2 | 12, 13, 14, 15, 16, 17 |
| 5 | 6 | 36, 37, 38, 39, 40, 41 |
| 6 | 3 | 18, 19, 20, 21, 22, 23 |
| 7 | 7 | 42, 43, 44, 45, 46, 47 |

It can be seen that in this example, every even numbered CCE is mapped to the next REG bundle in increasing frequency from the bottom to the middle of the available 48 RB CORESET frequency range. Every odd numbered CCE is mapped to the next REG bundle in increasing frequency from the middle to the top of the available 48 RB CORESET frequency range.

It can be seen, therefore, that for interleaved CCE to REG mapping, frequency resources for each PDCCH candidate will be distributed (essentially randomly) over the CORESET bandwidth. This has the potential to present a challenge for SBFD implementations in which UL communications from one UE 3 could interfere with the communication of DCI in a PDCCH for another UE 3.

### <PDSCH/PUSCH Resource Allocation>

Resource allocation for communication on the PDSCH or the PUSCH, in the telecommunication system 1, can be based on either of two types of resource allocation schemes.

In the first type of resource allocation (referred to as Type-0), the allocation is indicated by means of resource block assignment information that includes a bitmap indicating one or more resource block groups (RBGs) that have been allocated to the scheduled UE. Each RBG is a set of consecutive virtual resource blocks (VRBs). The size of the RBG (in number of resource blocks) is defined by a higher layer RBG size parameter (e.g., ‘rbg-Size’) and the size of the BWP to which the allocation relates. The RBG size parameter essentially indicates one of a plurality of possible RBG size configurations and the actual RBG size for each RBG size configuration is dependent on the BWP bandwidth. For example, for a 36 RB bandwidth the RBG size for a first RBG size configuration may be two RBs, whereas the RBG size for a second RBG size configuration may be four RBs. Contrastingly, for a 144 RB bandwidth the RBG size for the first RBG size configuration may be eight RBs, whereas the RBG size for the second RBG size configuration is sixteen RBs. Each RBG of a given BWP is therefore addressable via the bitmap without needing to increase the bitmap size for larger BWPs.

In the second type of resource allocation (referred to as Type-1), the allocation is indicated by means of resource block assignment information that indicates a set of contiguously allocated non-interleaved, or interleaved, VRBs within the active BWP. For non-interleaved VRBs, a VRB having index n is mapped to a corresponding PRB having the same index n. For interleaved VRBs, the VRB-to-PRB mapping involves bundling the RBs (both virtual and physical) into RB bundles (RBBs) in increasing order of RB indices and RBB indices. Each virtual RBB (VRBB) is mapped to a physical RBB (PRBB) based on block interleaving such that a given VRBB index may not be the same as the corresponding PRBB index. Thus, if a set of contiguous VRBBs are assigned to a UE 3 the corresponding PRBBs may not be contiguous in frequency, and may, instead, be distributed at different (separated) positions in the bandwidth of the corresponding BWP.

Dynamic switching between the different types of resource allocation is possible by means of an indication included within DCI having an appropriate DCI format (e.g. DCI format 0_1 (for PUSCH), DCI format 1_1 (for PDSCH), ‘compact’ DCI format 0_2 (for PUSCH), or ‘compact’ DCI format 1_2 (for PDSCH)).

It will be appreciated that for multi-slot PUSCH/PDSCH, frequency domain resource allocations will remain the same for all slots. Nevertheless, frequency resources for adjacent slots may still be different where frequency hopping is used (as described in more detail later).

It can be seen, therefore, that for the second type (Type-1) resource allocation (with interleaving) frequency resources for PDSCH/PUSCH may be distributed (essentially randomly) over the BWP bandwidth. This has the potential to present a challenge for SBFD implementations in which UL/DL communications of one UE 3 could interfere with the PDSCH/PUSCH communication of another UE 3.

### <Frequency Hopping>

For communication on the PUSCH, in the telecommunication system 1, one of a plurality of different frequency hopping modes can be configured.

A first hopping mode, for example, comprises intra-slot frequency hopping in which frequency hopping can occur within a slot. Intra-slot frequency hopping is applicable both to single slot and multi-slot PUSCH transmission.

A first hopping mode, for example, comprises inter-slot frequency hopping in which frequency hopping can occur from slot-to-slot. Inter-slot frequency hopping is applicable to multi-slot PUSCH transmission.

For intra-slot hopping, the starting RB in each hop is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix}$$

where i=0 and i=1 are the first hop and the second hop respectively, and RBₛₜₐᵣₜ is the starting RB within the UL BWP, as calculated from the resource block assignment information (e.g., of a Type-1 resource allocation), RB_{offset} is the frequency offset in RBs between the two frequency hops, and

$${N}_{BWP}^{size}$$

is the size of the BWP in RBs.

For inter-slot hopping, the starting RB during slot nₛ^{μ}, is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) & {n}_{s}^{μ} mod 2 = 1\end{matrix}$$

where nₛ^{μ} is the current slot number within a radio frame, where a multi-slot PUSCH transmission can take place, RBₛₜₐᵣₜ is the starting RB within the UL BWP, as calculated from the resource block assignment information (e.g., of a Type-1 resource allocation), RB_{offset} is the frequency offset in RBs between the two frequency hops, and

$${N}_{BWP}^{size}$$

is the size of the BWP in RBs.

For the second type of resource allocation (e.g., Type-1), the UE 3 performs PUSCH frequency hopping if the frequency hopping field in a corresponding detected DCI format (or in a random-access response UL grant) is set to 1. The frequency offsets may be configured by a higher layer parameter (e.g., a frequencyHoppingOffsetLists parameter), where one of the higher layer configured offsets may be indicated in the UL grant.

### <Provision of Full Duplex>

The UEs 3 and base station 5 of the telecommunication system 1 are mutually configured for providing full duplex (FD) communication on a TDD carrier. Specifically, the UEs 3 and base station 5 of the telecommunication system 1 are configured to facilitate subband non-overlapping FD (SBFD) communication.

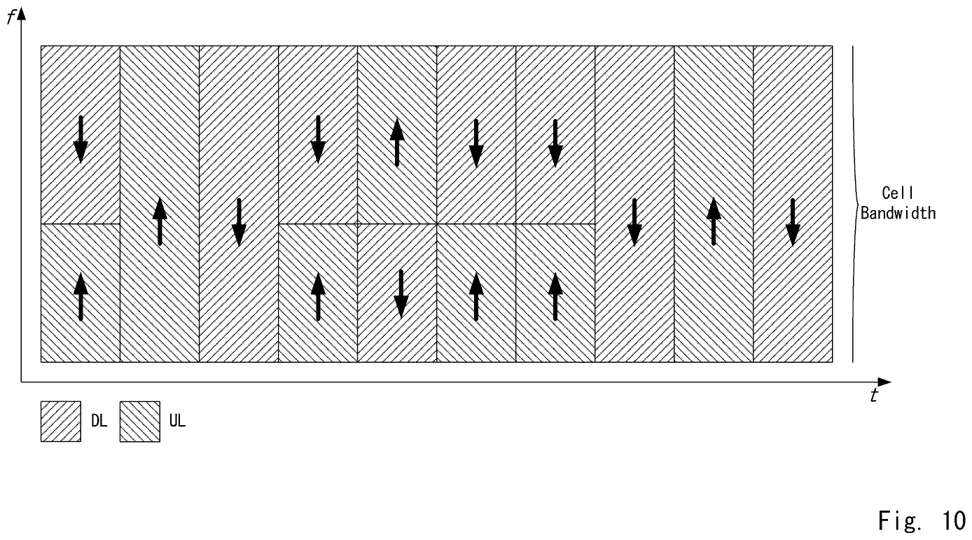

For example, as seen in FIG. 10, which is a simplified time frequency diagram showing an illustrative example of a full duplex configuration that may be used in the telecommunication system 1, the different UE specific slot configurations allow a slot within the cell bandwidth to effectively be configured as an FD slot by configuring that slot for one UE as an uplink slot, while the same slot is configured as a downlink slot for another UE (or vice versa). Thus, UL communication from one UE 3 in the cell bandwidth may occur in parallel with DL communication to another UE 3. It will be appreciated that while not specifically illustrated the parallel UL/DL communication may be configured at a symbol level as well as at the slot level.

It will be appreciated that the base station 5 is configured to schedule frequency resources of any slot configured as an FD slot, to ensure that the frequency resources scheduled for UL communication by one UE 3 are part of a different subband than the frequency resources scheduled for DL communication to another UE 3. Accordingly, subband non-overlapping FD communication can thus take place at the base station 5 while half-duplex communication takes place at the UEs 3.

The base station 5 is thus able to configure one or more of the slots (and/or symbols) of the TDD carrier as FD slots (and/or symbols) or more specifically, in a case where, subband non-overlapping full duplex (SBFD) is used for full duplex operation, SBFD slots (and/or symbols). For convenience, slots/symbols which contain both UL and DL subbands, from the base station's perspective, will be referred to generally as ‘SBFD’ slots/symbols, or slots/symbols with a configured UL subband/DL subband. Other slots/symbols, which only contains communication in a single transmission direction (UL or DL) will generally be referred to as legacy (UL or DL) slots/symbols or non-SBFD (UL or DL) slots/symbols.

It will be appreciated that, from a UE perspective, an SBFD slot or symbol may appear to be a legacy UL, DL, or flexible symbol because the UE 3 is operating using half duplex on the TDD carrier. Nevertheless, a UE 3 may be informed of the FD/SBFD slots/symbols, either implicitly or explicitly, to allow the UE 3 to assist with interference avoidance/alleviation. For example, if the UE 3 can identify the FD/SBFD slots/symbols then the UE 3 may: contribute to the implementation of an appropriate frequency gap between the frequency resources used by that UE 3 (e.g., for UL or DL) and the frequency resources used by another UE 3 (e.g., for DL or UL); avoid, reconfigure, and/or apply updated resources, in respect of certain transmissions/receptions (e.g., for semi-static transmission such as SPS.

For example, the base station 5 may explicitly indicate which slots/symbols are configured as FD/SBFD type slots/symbols, for example, dynamically using DCI with an appropriate DCI format and/or using a Medium Access Control (MAC) Control Element (CE). The base station 5 may, alternatively or additionally explicitly indicate which slots/symbols are configured as FD/SBFD type slots/symbols via system information or dedicated (RRC) signalling (for example, by means of frame structure signalling similar to that used for the cell specific and/or dedicated TDD UL/DL slot configuration). A UE 3 may implicitly determine whether a slot/symbol is configured as an FD/SBFD type slots/symbol based on other information received from the network (base station 5). For example, the UE may assume that an SBFD slot occurs when the base station 5 indicates that an UL transmission is to take place during a DL configured slot or that a DL transmission is to take place during a UL configured slot.

It will be appreciated that there are different variations which exist for implementation of SBFD, and the telecommunication system 1 may be configured to provide support for any suitable SBFD schemes. Such schemes may include, for example, inter-BWP full duplex and/or intra-BWP full duplex.

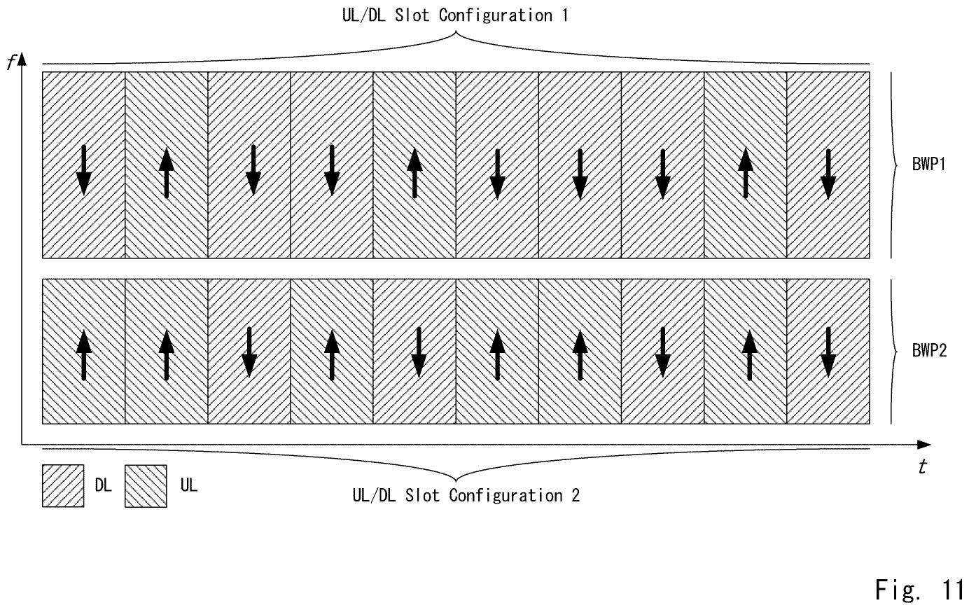

Referring to FIG. 11, for example, which is a simplified time frequency diagram showing an illustrative example of an inter-BWP type of full duplex configuration, inter-BWP full duplex involves parallel UL and DL transmission in different BWPs in which a particular slot of one BWP may be configured as an uplink slot while the corresponding slot (i.e., having the same timing) in another BWP may be configured as a downlink slot (or vice versa). Thus, UL from one UE 3 in one BWP may occur in parallel with DL communication to another UE 3 in another BWP.

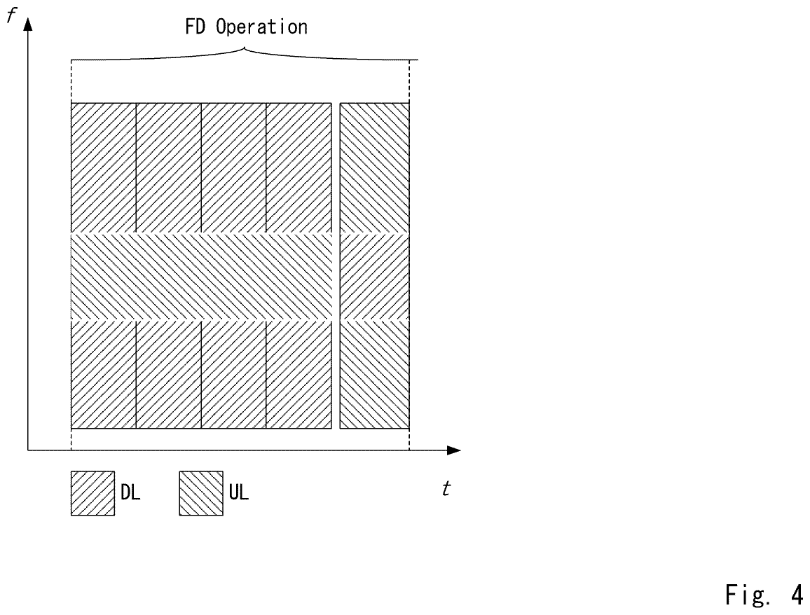

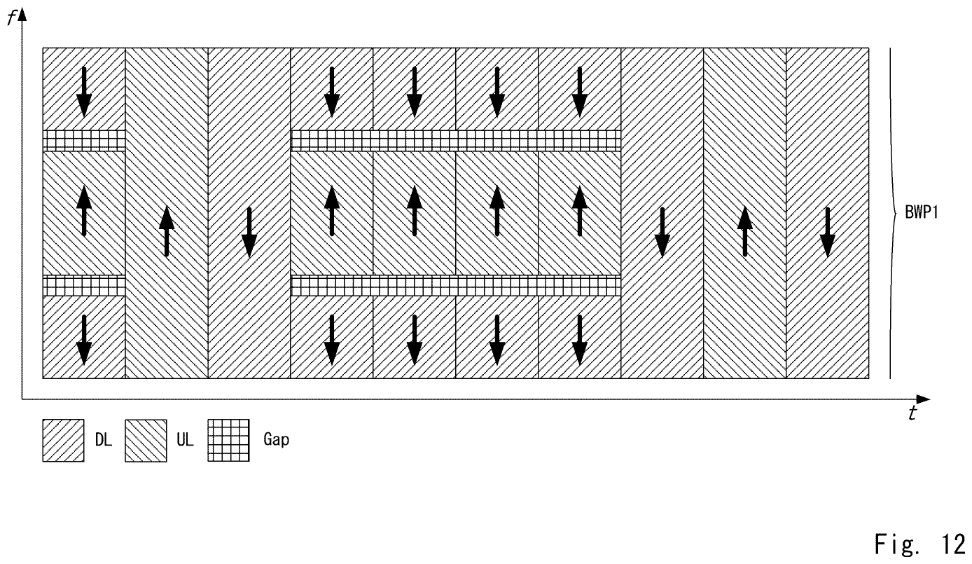

Referring to FIG. 12, on the other hand, which is a simplified time frequency diagram showing an illustrative example of an intra-BWP type of full duplex configuration, intra-BWP full duplex involves parallel UL and DL transmission in the same BWP. In the example illustrated in FIG. 12, an UL subband is effectively inserted within a slot/symbol configured as a (legacy) DL or flexible slot/symbol of a BWP. Specifically, each time resource of the BWP is configured as a DL, a UL, or a flexible slot/symbol (for example using a TDD configuration technique as described with reference to FIGS. 4 and 5). An UL subband (e.g., a set of contiguous UL frequency resources) is then configured within the BWP for at least a subset of one or more of the DL or flexible slots/symbols to effectively form a slot/symbol that consists of a UL subband and one or two DL subbands. The configuration of one or more UL subbands may be achieved in any suitable way, for example by semi-static configuration and/or dynamic configuration. A guard band (frequency gap) may be configured, between the UL subband and each DL subband, where no transmission is performed, thereby helping to avoid interference. The base station 5 can then schedule UL transmission in the UL subband and DL transmission in one or more DL subbands as necessary. It will be appreciated that while FIG. 12 shows a UL subband being inserted in a downlink or flexible slot/symbol, a similar mechanism may also be used to insert a DL subband within an UL or flexible slot/symbol to achieve SBFD.

Notwithstanding that an UL (or DL) subband may be configured in a slot/symbol configured (e.g., by a TDD configuration) as a DL (or UL) slot/symbol, it will be appreciated that it would be particularly beneficial for the base station to be able to schedule DL (or UL) transmission within a configured UL (or DL) subband dynamically (for example, when there is no UL (or DL) transmission required) to improve radio resource utilisation.

### <SBFD Considerations>

Beneficially, as described in more detail, the base station 5 and the UEs 3 of the telecommunication system 1 are mutually configured to implement one or more procedures that have been adapted to take into consideration the potential impacts of implementing SBFD on the wider communication system and, in particular, on older (‘legacy’) UEs that are not configured for SBFD communication. For example, the described procedures include one or more procedures that can beneficially contribute to ensuring that UEs that are not configured for SBFD communication can effectively coexist with newer ‘SBFD aware’ UEs 3 in the telecommunication system 1.

For example, as described in more detail later, the base station 5 and the UEs 3 of the telecommunication system 1 may be mutually configured to implement one or more enhanced procedures to take account of the potential impact of implementing SBFD on the configuration of common search spaces. Specifically, given that legacy UEs (which use common search spaces) will not implement modified behaviours to take account of SBFD, their PDCCH reception procedure via a common search space needs to remain essentially the same as for earlier standards releases (e.g., Rel-17). However, common search spaces will also be used by more modern UEs (e.g., Rel-18 UEs) that configured to support SBFD (and are therefore effectively aware of SBFD configurations).

Moreover, as described in more detail later, the base station 5 and the UEs 3 of the telecommunication system 1 may be mutually configured to implement one or more enhanced procedures for the allocation of communications resources (e.g., frequency resources) for CORESETs (PDCCHs), PDSCHs and/or PUSCHs, for UEs 3 that support SBFD. Specifically, SBFD supporting UEs will be aware of the SBFD configuration in SBFD slots (e.g., the DL or flexible slots in which an UL subband is configured (or vice versa)). Since the UEs 3 are aware of the configurations for SBFD, the SBFD configuration may be taken into account in an enhanced resource configuration procedure for the different physical channels during SBFD slots. Similarly, one or more enhanced procedures for the allocation of communications resources may alternatively or additionally include one or more enhancements for frequency hopping and/or frequency interleaving to take account of the impact of SBFD operation.

Further, the base station 5 and the UTs 3 of the telecommunication system 1 may be mutually configured to implement one or more enhanced procedures that take account of the possibility that multi-slot UL/DL transmission may include both SBFD and non-SBFD slots. Specifically, for multi-slot transmission including both SBFD and non-SBFD slots, only a subset of the frequency resources is available for the UL/DL transmissions in SBFD slots/symbols. Accordingly, the telecommunication system 1 may implement one or more enhanced procedures, for multi-slot UL/DL transmission, that govern the extent to which UL/DL transmission, which spans both SBFD and non-SBFD slots/symbols, should be considered valid and (hence allowed).

It will be appreciated that while several procedures are described that may be implemented in the telecommunication system 1 to provide a corresponding benefit, not all the procedures need to be implemented to achieve a beneficial result. Specifically, any one of the procedures may be implemented independently of the others. Nevertheless, many of the procedures are not mutually exclusive and can be implemented together where it is technically appropriate to do so.

### <Configuration of Common Search Spaces for PDCCH Transmissions in the Context of SBFD>

As indicated above, the base station 5 and the UEs 3 of the telecommunication system 1 may be mutually configured to implement one or more enhanced procedures to take account of the potential impact of implementing SBFD on the configuration of common search spaces.

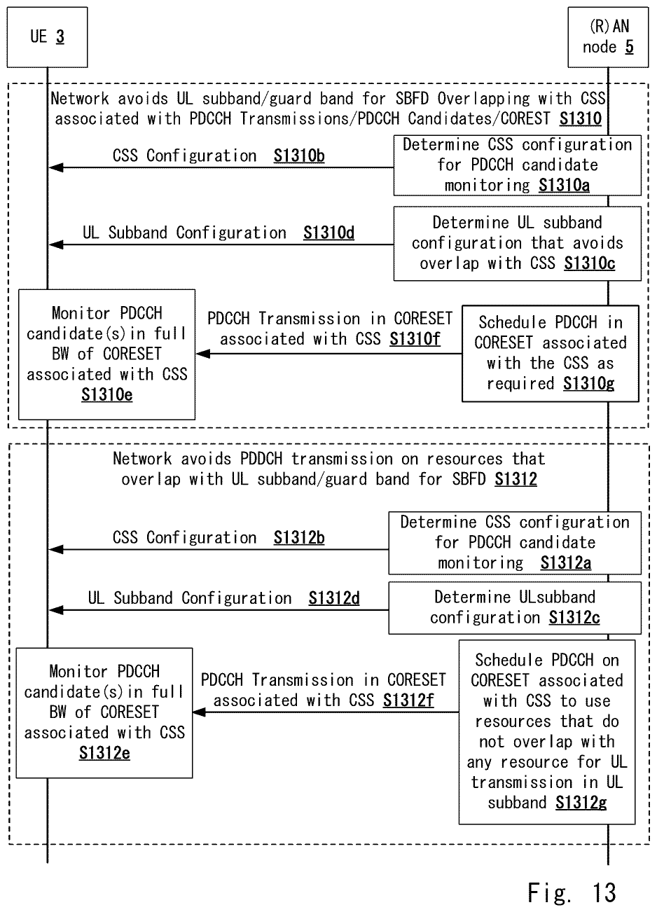

A number of possible procedures for implementing common search spaces in the context of SBFD will now be described in more detail, by way of example only, with reference to FIGS. 13 to 17.

Referring to FIG. 13, which is a simplified sequence diagram illustrating a number of procedures for CSS configuration that may be employed in the in the telecommunication system 1, in a first procedure for CSS configuration, the network is not allowed to configure an UL subband/guard band for SBFD (e.g., in a slot/symbol configured for DL) which overlaps (either partially or fully) with an associated CSS in which the UE 3 is to receive PDCCH transmissions, monitor PDCCH candidates, and/or monitor a CORESET specifically associated with the CSS. In this procedure, therefore, the UE 3 is configured to behave as if it does not expect the network to configure an UL subband which partially/fully overlaps with PDCCH transmissions, PDCCH candidates, and/or a CORESET associated with a CSS.

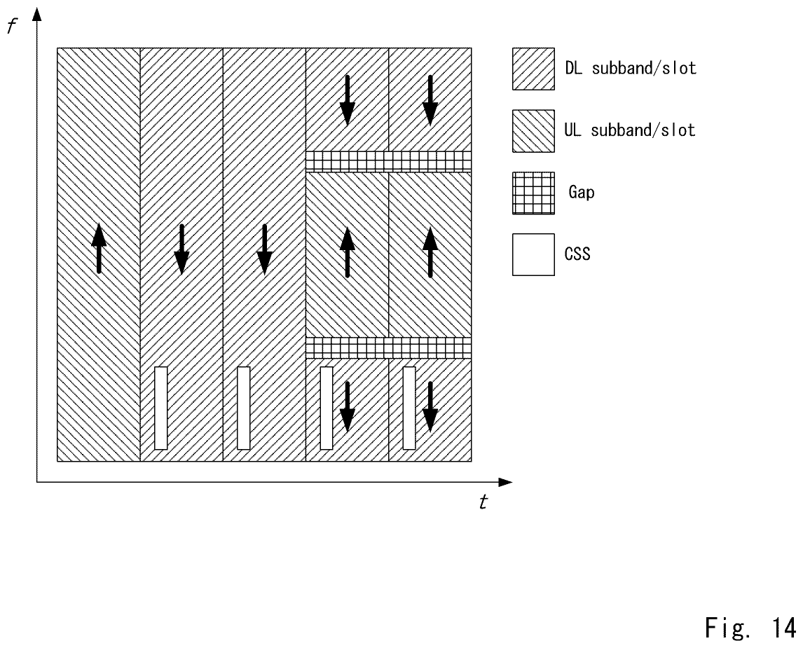

A CSS configuration according to this procedure is illustrated in FIG. 14, which is a simplified time frequency diagram showing an illustrative example of the CSS configuration.

Specifically, as illustrated at S1310 in FIG. 13 and seen in FIG. 14, the base station 5 avoids configuring an UL subband (and guard band) for SBFD that overlaps with the CSS (or that overlaps with PDCCH transmissions, PDCCH candidates, and/or a CORESET associated with a CSS).

In more detail, the base station 5 determines a CSS configuration for PDCCH monitoring at S1310a and configures the UE 3 (and other UEs in a cell 9 of the base station) accordingly at S1310b. The base station 5 also determines, at S1310c, an UL subband configuration, for the purposes of SBFD (e.g., in one or more slots/symbols configured as DL slots/symbols). This UL subband configuration is configured, by the base station 5, to ensure that there is no overlap with the CSS for PDCCH monitoring (or overlap with PDCCH transmissions, PDCCH candidates, and/or a CORESET associated with the CSS). The UL subband configuration is provided to one or more UEs 3 that support SBFD, in the cell 9 of the base station 5, at S1310d. It will, nevertheless, be appreciated that the CSS configuration may be configured to avoid overlaps with a previously configured UL subband configuration.

Any UE in the cell 9 can then monitor the full bandwidth of the CORESET associated with the CSS, regardless of whether it is a legacy UE or a UE 3 that supports SBFD (as seen at S1310e). Accordingly, in the event that the base station 5 schedules (at S1310g) and performs (at S1310f) a PDCCH transmission in the CORESET associated with the CSS, UEs in the cell 9 can successfully receive that PDCCH transmission.

As seen in FIG. 13, in a second procedure for CSS configuration, the network is allowed to configure an UL subband/guard band for SBFD (e.g., in a slot/symbol configured for DL) which overlaps (either partially or fully) with an associated CSS in which the UE 3 is to monitor PDCCH candidates and/or monitor a CORESET specifically associated with the CSS. However, in this procedure when the base station 5 schedules a transmission of downlink control information on the PDCCH, the base station 5 avoids any overlap (either partial or full) of the resource scheduled for the PDCCH transmission with any UL transmission resources scheduled in SBFD slots/symbols. In this procedure, therefore, the UE 3 is configured to assume that the full CORESET bandwidth associated with the CSS is available for PDCCH transmissions, even if the UL subband partially/fully overlaps with the PDCCH transmissions, PDCCH candidates, and/or associated CORESET and it is left to the network to schedule the PDCCH in a manner that ensures that the PDCCH does not overlap with any resource of an UL transmission using UL subband configured for SBFD, when such an UL subband is in use.

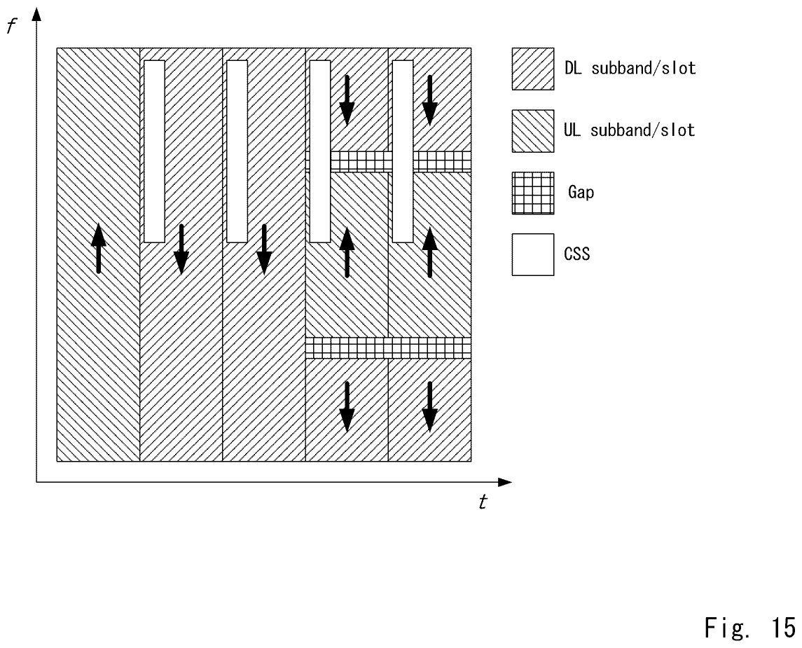

A CSS configuration according to this procedure is illustrated in FIG. 15, which is a simplified time frequency diagram showing another illustrative example of CSS configuration.

Specifically, as illustrated at S1312 in FIG. 13 and seen in FIG. 15, the base station 5 avoids scheduling resources for a PDCCH transmission that overlap with resources of an UL transmission using UL subband for SBFD (e.g., in a slot/symbol configured for DL).

In more detail, the base station 5 determines a CSS configuration for PDCCH monitoring at S1312a and configures the UE 3 (and other UEs in a cell 9 of the base station) accordingly at S1312b. The base station 5 also determines, at S1312c, an UL subband configuration, for the purposes of SBFD (e.g., in a slot/symbol configured for DL). In this example, the UL subband configuration may be configured, by the base station 5, in a manner that overlaps with the CSS for PDCCH monitoring. The UL subband configuration is provided to one or more UEs 3 that support SBFD, in the cell 9 of the base station 5, at S1312d.

Any UE in the cell 9 can then monitor the full bandwidth of the CORESET associated with the CSS, regardless of whether it is a legacy UE or a UE 3 that supports SBFD (as seen at S1312e).

In the event that the base station 5 schedules (at S1312g) and performs (at S1312f) a PDCCH transmission in the CORESET associated with the CSS, the base station 5 ensures that the resources scheduled at S1312g do not overlap with any resource for an UL transmission using UL subband configured, for the purposes of SBFD (e.g., in a slot/symbol configured for DL).

UEs in in the cell 9 can successfully receive that PDCCH transmission regardless of any overlap between the CSS and the UL subband configured for the purposes of SBFD.

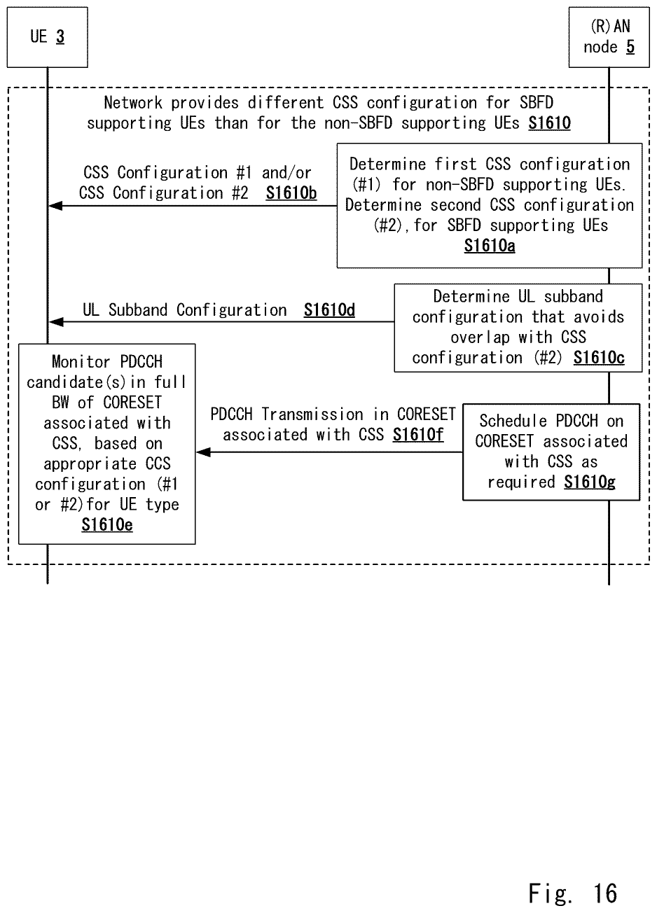

Referring to FIG. 16, which is a simplified sequence diagram illustrating another procedure for CSS configuration that may be employed in the in the telecommunication system 1, in this other procedure for CSS configuration, the network configures a different configuration of CSS for UEs 3 that support SBFD (or UEs 3 specifically configured with an UL subband for SBFD in a slot/symbol configured for DL), than for non-SBFD supporting (legacy) UEs.

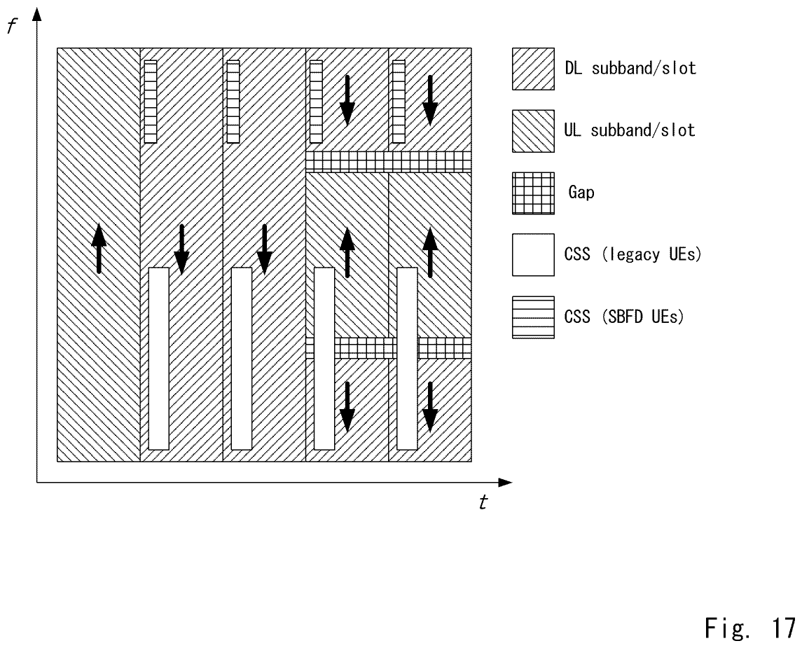

A CSS configuration according to this procedure is illustrated in FIG. 17, which is a simplified time frequency diagram showing an illustrative example of the CSS configuration.

Specifically, as illustrated at S1610 in FIG. 16 and seen in FIG. 17, the base station 5 configures a different CSS location for the SBFD supporting UEs 3 than for the non-SBFD supporting UEs and avoids the SBFD specific CSS overlapping with the UL Subband (and guard band) configured for SBFD.

In more detail, the base station 5 determines, at S1610a, a first CSS configuration (#1) for PDCCH monitoring by non-SBFD UEs, and a second CSS configuration (#2) for PDCCH monitoring by SBFD UEs. The base station 5 configures the UE 3 (and other UEs in a cell 9 of the base station) accordingly at S1610b (while this is shown as a single configuration signal, it will be appreciated that different signalling may be used, for each CSS configuration (#1, #2), for different UEs or groups of UEs).

The base station 5 determines, at S1610c, an UL subband configuration, for the purposes of SBFD (e.g., in a slot/symbol configured for DL). This UL subband configuration is configured, by the base station 5, to ensure that there is no overlap with the CSS for PDCCH monitoring by SBFD supporting UEs (or UEs 3 specifically configured with an UL subband for SBFD in a slot/symbol configured for DL). The UL subband configuration is provided to one or more UEs 3 that support SBFD, in the cell 9 of the base station 5, at S1610d. It will, nevertheless, be appreciated that the CSS configuration for SBFD supporting UEs may be configured to avoid overlap with a previously configured UL subband configuration.

Any UE in the cell 9 can then monitor the full bandwidth of the CORESET associated with a corresponding CSS configuration (#1 or #2), regardless of whether the UE is a legacy UE or a UE 3 that supports SBFD (as seen at S1610e). Accordingly, in the event that the base station 5 schedules (at S1610g) and performs (at S1610f) a PDCCH transmission in the CORESET associated with the CSS, UEs in the cell 9 can successfully receive that PDCCH transmission.

It will be appreciated that this procedure may be more suitable for a specific type of PDCCH CSS (e.g., Type 3) than for other PDCCH CSS types.

It will be understood that any of the procedures described with reference to FIGS. 13 to 17 may be implemented independently of one another. Nevertheless, any of the procedures described with reference to FIGS. 13 to 17 may be implemented in combination with one or more of the other procedures (e.g., for use with different PDCCH CSS types).

Moreover, it will be appreciated that while the procedures described with reference to FIGS. 13 to 17 may be applicable in respect of all PDCCH transmissions via a CSS this need not be the case.

For example, one or more of the procedures may be applied in respect of PDCCH transmissions associated specifically with one or more broadcast channels (e.g., PDCCH transmissions associated with a DCI format with a CRC scrambled by P-RNTI or SI-RNTI). Similarly, one or more of the procedures may be applied in respect of all PDCCH transmissions other than those associated with a DCI format with a CRC scrambled by a C-RNTI.

Moreover, one or more of the procedures may be applied only in respect of PDCCH transmissions which are required to be received by both legacy and SBFD supporting UEs. This may be appropriate, for example, where one or more common channels (e.g., a random-access channel (RACH)) can be configured separately for SBFD UEs and for legacy UEs. Hence, the described procedures may not need to be applied, in respect of a CSS associated with such channels, by SBFD UEs. However, where SBFD supporting UEs need to receive PDCCH transmissions which are common to legacy UEs and the SBFD supporting UEs (e.g. system information), then for these PDCCH transmissions the above procedures may be applied.

It will also be appreciated that a different procedure may be applied in respect of each PDCCH type or CSS set.

Whilst the procedures described with reference to FIGS. 13 to 17 are concerned with avoiding overlap between an UL subband configured for the purposes of SBFD (e.g., in a slot/symbol configured for DL) and PDCCH transmissions, PDCCH candidates, and/or a CORESET associated with a CSS, it will be appreciated that similar procedures may be applicable in respect of other downlink transmissions.

For example, similar procedures may be applied to avoid overlap between the UL subband and: any downlink transmission scheduled using a DCI received in a common search space; any broadcast transmission or other similar transmission associated with multiple UEs (e.g., P-RNTI, SI-RNTI based PDSCH transmissions) scheduled using DCI received in a common search space; and/or any other broadcast transmission such as a system information broadcast, transmission of cell specific reference signals and/or the like.

### <Configuration of CORESET for PDCCH Transmissions/PDCCH Candidates in the Context of SBFD>

As indicated above, the base station 5 and the UEs 3 of the telecommunication system 1 may be mutually configured to implement one or more enhanced procedures for the allocation of communications resources (e.g., frequency resources) for CORESETs (PDCCHs), PDSCHs and/or PUSCHs, for UEs 3 that support SBFD.

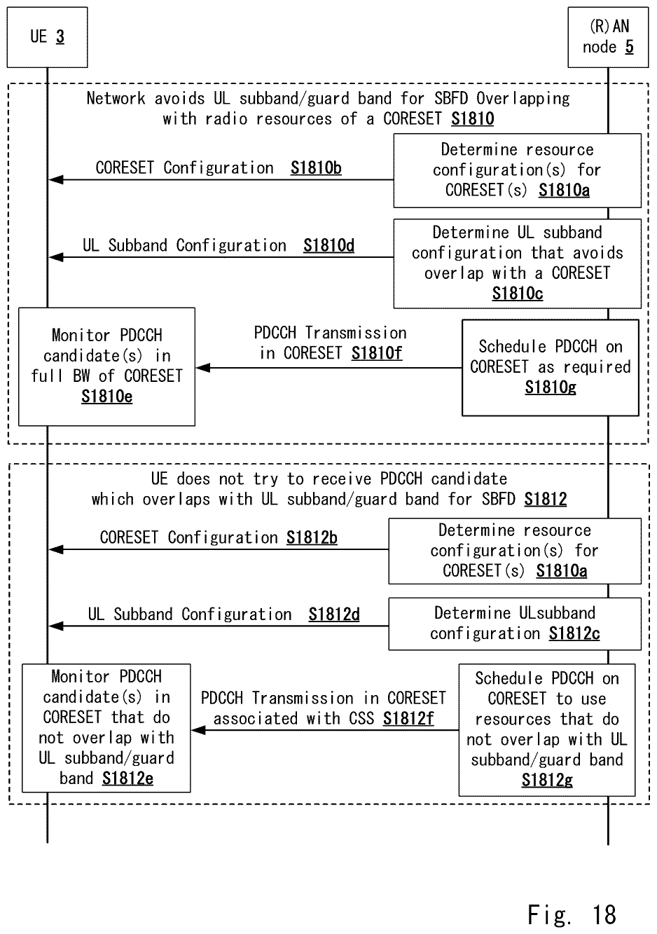

A number of possible procedures for configuring the resource allocation for CORESETS, in the context of SBFD, will be described in more detail, by way of example only, with reference to FIGS. 18 to 23.

Referring to FIG. 18, which is a simplified sequence diagram illustrating a number of procedures for CORESET resource allocation that may be employed in the telecommunication system 1, in a first procedure for CORESET configuration (S1810), the network does not configure an UL subband/guard band for SBFD (e.g., in a slot/symbol configured for DL), which overlaps (either partially or fully) with associated frequency resources (and/or time resources) for a CORESET. In this procedure, therefore, the UE 3 is configured to behave as if it does not expect the network to configure an UL subband which partially/fully overlaps with the radio resources of the CORESET. It will be appreciated that this approach has the benefit that it can be implemented with relatively little impact on existing techniques albeit that it may reduce resource utilization.

In more detail, the base station 5 determines one or more CORESET configurations at S1810a and configures the UE 3 accordingly at S1810b. The base station 5 also determines, at S1810c, an UL subband configuration for the purposes of SBFD (e.g., in a slot/symbol configured for DL). This UL subband configuration is configured, by the base station 5, to ensure that there is no overlap with a CORESET. The UL subband configuration is provided to one or more UEs 3 that support SBFD, in the cell 9 of the base station 5, at S1810d. It will, nevertheless, be appreciated that the CORESET may be configured to avoid overlap with a previously configured UL subband configuration.

The UE 3 can then monitor candidate PDCCHs in the full bandwidth of the CORESET, regardless of whether it is a legacy UE or a UE 3 that supports SBFD (as seen at S1810e). Accordingly, in the event that the base station 5 schedules (at S1810g) and performs (at S1810f) a PDCCH transmission in the CORESET, UEs in the cell 9 can successfully receive that PDCCH transmission.

As seen in FIG. 18, in a second procedure for CORESET resource configuration (S1812), the network may configure an UL subband/guard band for SBFD (e.g., in a slot/symbol configured for DL), which overlaps (either partially or fully) with an associated CORESET in which the UE 3 is to monitor PDCCH candidates. However, in this procedure the UE does not try to receive a PDCCH candidate which partially/fully overlaps with the UL subband/guard band.

In more detail, the base station 5 determines a CORESET resource configuration for PDCCH monitoring at S1812a and configures the UE 3 accordingly at S1812b. The base station 5 also determines, at S1812c, an UL subband configuration, for the purposes of SBFD, for one or more slots/symbols configured as slots/symbols for DL. In this example, the UL subband configuration may be configured, by the base station 5, in a manner that overlaps with a CORESET. The UL subband configuration is provided to the UE 3 at S1812d.

The UE 3 can then monitor PDCCH candidates in the CORESET at S1812e without attempting to receive any PDCCH candidates that overlap (fully or partially) with the UL subband for SBFD.

In the event that the base station 5 schedules (at S1812g) and performs (at S1812f) a PDCCH transmission using the CORESET, the base station 5 may ensure that the resources scheduled at S1812g do not overlap with any UL subband configured for the purposes of SBFD.

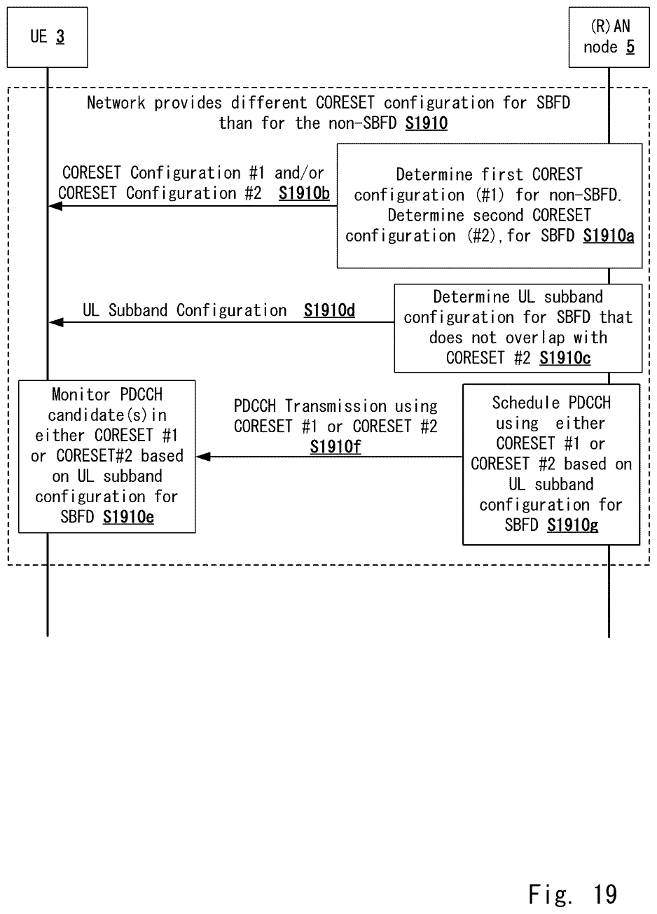

Referring to FIG. 19, which is a simplified sequence diagram illustrating another procedure for CORESET resource configuration that may be employed in the in the telecommunication system 1, the network may configure a different CORESET configuration for the purposes of SBFD than for non-SBFD (S1910).

In more detail, the base station 5 determines, at S1910a, a first (non-SBFD specific) CORESET resource configuration (#1) for the purposes of non-SBFD, and a second (SBFD specific) CORESET resource configuration (#2) for the purposes of SBFD. The base station 5 configures the UE 3 accordingly at S1910b (while this is shown as a single configuration signal, it will be appreciated that different signalling may be used, for each CORESET resource configuration (#1, #2)).

There are different possible ways in which the two CORESET resource configurations can be provided to UE. For example, two separate CORESETs may be configured which share some of the same properties (e.g., a common transmission configuration indicator (TCI) state configuration) and these can be indicated as part of common configuration information. In another example, two separate frequency/time resource configurations may be configured for each configured CORESET for SBFD and non-SBFD, respectively. In another example, network configures UE with non-SBFD CORESET configuration and UE determines the SBFD CORESET configuration from non-SBFD CORESET configuration by assuming that SBFD CORESET frequency resources do not include the frequency resources which overlap with configured UL subband or guard band. In another example, non-SBFD CORESET configuration is configured by network and the time/frequency resources of the SBFD CORESET configuration can, potentially, be indicated dynamically by the network. For example, this information for configuring the time/frequency resources may be indicated via DCI which schedules dynamic SBFD slots. Moreover, while the information for configuring the time/frequency resources may be provided explicitly as shown in FIG. 19 (e.g., as an explicit frequency/time offset provided within the DCI), the information for configuring the time/frequency resources may be provided implicitly (e.g., the UE 3 determines that, for dynamically scheduled SBFD slots, a pre-configured frequency/time offset is applicable).

The base station 5 determines, at S1910c, an UL subband configuration, for the purposes of SBFD, for one or more slots/symbols configured as slots/symbols for DL. This UL subband configuration is configured, by the base station 5, to ensure that there is no overlap with the resources of the CORESET resource configuration for SBFD. The UL subband configuration is provided to the UE 3 at S1910d. It will, nevertheless, be appreciated that the CORESET resource configuration for SBFD may be configured to avoid overlap with a previously configured UL subband configuration. Accordingly, the UE can assume that for SBFD, the associated CORESET frequency resources (at least) do not overlap with the UL subband frequency resources (in addition to any configured guard band frequency resources).

The UE 3 can then monitor PDCCH candidates in either the first CORESET resource configuration or the second CORESET resource configuration, based on the UL subband configuration, and an associated rule (or set of rules) that defines which CORESET resource configuration should be used. In the event that the base station 5 schedules (at S1910g) and performs (at S1910f) a PDCCH transmission, the base station 5 schedules the PDCCH to use either the first CORESET resource configuration or the second CORESET resource configuration, based on the UL subband configuration, and the associated rule (or set of rules) that defines which CORESET resource configuration should be used.

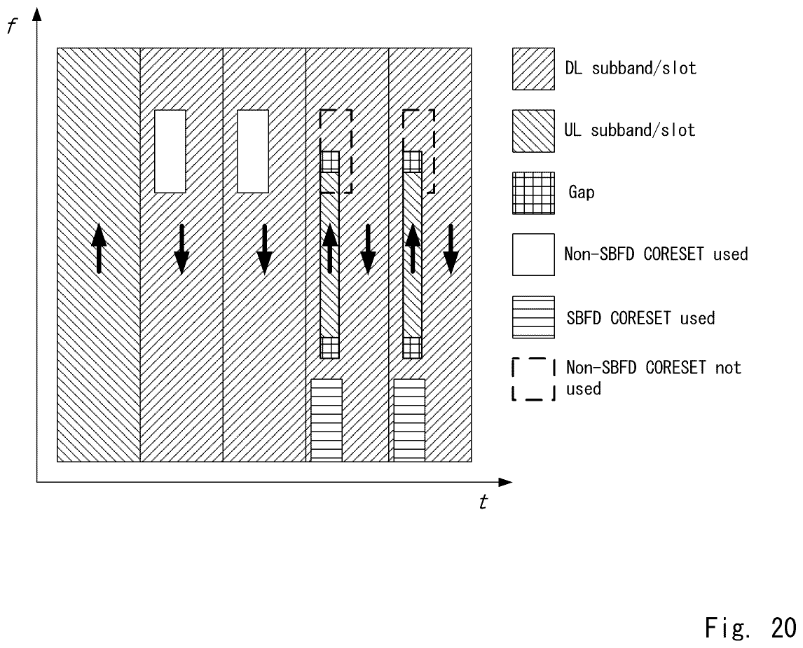

Possible rules for determining which CORESET resource configuration to use will now be described, by way of example only, with reference to FIGS. 20 to 23, each of which is a simplified time frequency diagram showing an illustrative example of use two different CORESET configurations.

Referring to FIG. 20, for example, one or more rules may define that the SBFD specific CORESET based configuration is used in the event that any PDCCH candidate of the non-SBFD specific CORESET configuration partially/fully overlaps (in frequency and time) with a configured UL subband (or guard band).

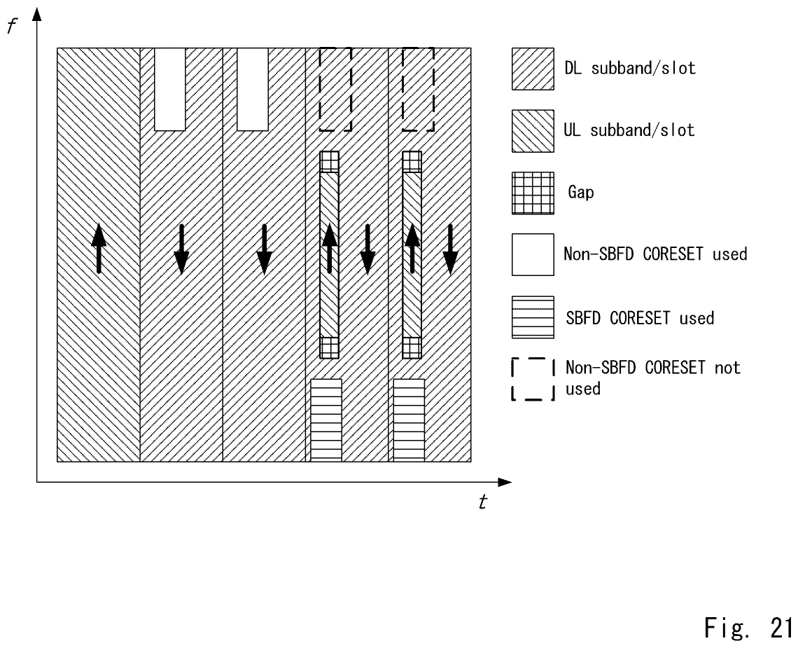

Referring to FIG. 21, one or more rules may define that the SBFD specific CORESET based configuration is used in the event that any PDCCH candidate of the non-SBFD specific CORESET configuration partially/fully overlaps (in time) with at least one of SBFD symbol (even if the frequency resources do not overlap).

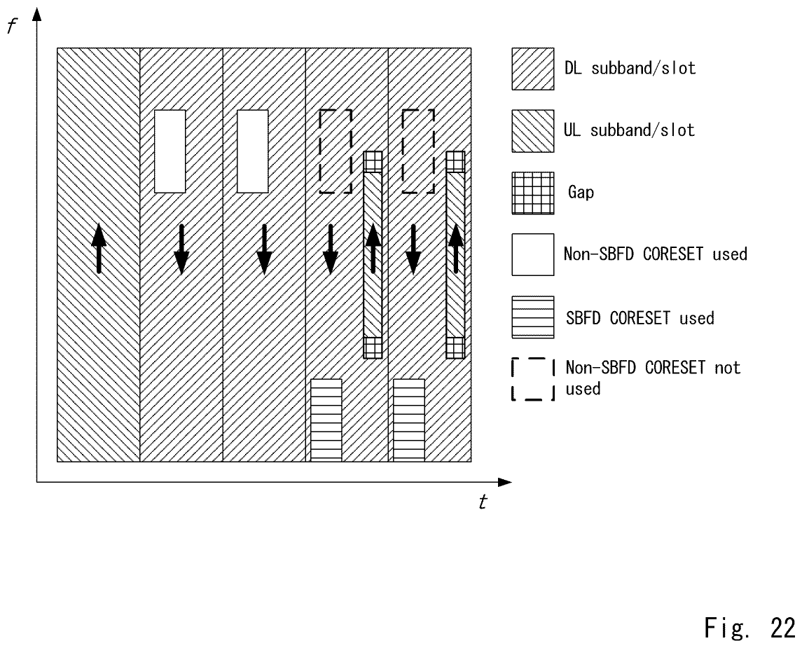

Referring to FIG. 22, one or more rules may define that the SBFD specific CORESET based configuration is used in any slot in which at least a symbol is configured for SBFD (even if the SBFD specific CORESET does not overlap with that symbol and/or the frequency resources of the UL subband).

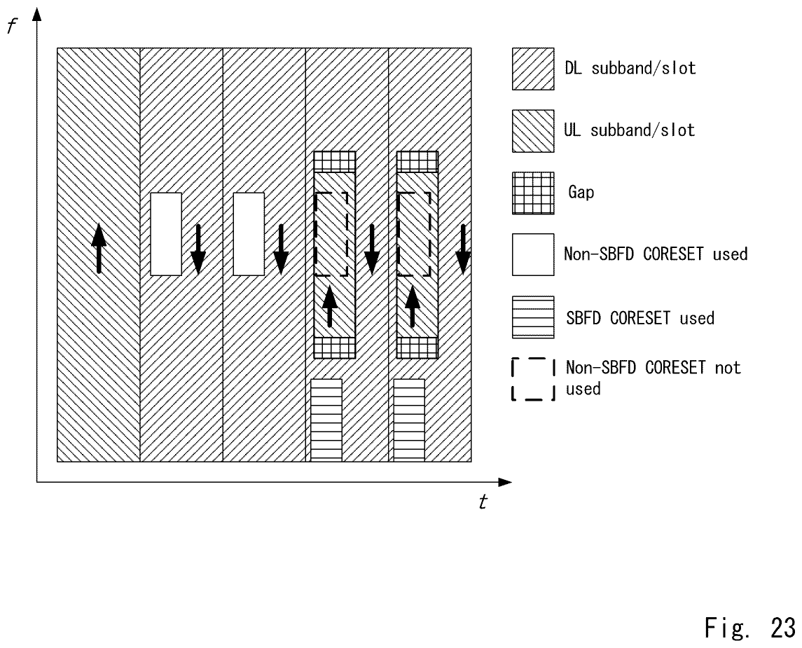

Referring to FIG. 23, one or more rules may define that the SBFD specific CORESET based configuration is used in the event that all PDCCH candidates of the non-SBFD specific CORESET configuration partially/fully overlap with UL subband (or guard band).

It will be appreciated that, in a variation of the above rules, the use of the SBFD specific CORESET based configuration may depend on the location of a PDCCH search space (CSS or USS) associated with the CORESET rather than PDCCH candidates. For example, one or more rules may define that the SBFD specific CORESET based configuration is used in the event that a PDCCH search space associated with the non-SBFD specific CORESET configuration partially/fully overlaps with at least one of SBFD symbol (even if the frequency resources do not overlap).

Moreover, the SBFD specific CORESET and non-SBFD specific CORESET could be implemented by defining two different search spaces (one for SBFD and other for non-SBFD) which are configured to UE 3 by the base station 5. Each search space may then be associated with a different respective CORESET configuration. The selection between the search spaces may still be based on any of the rules discussed above.

It will be understood that any of the procedures described with reference to FIGS. 18 to 23 may be implemented independently of one another. Nevertheless, any of the procedures described with reference to FIGS. 18 to 23 may be implemented in combination with one or more of the other procedures (e.g., for use with different PDCCH types).

### <Configuration of Resources for Interleaving/Frequency Hopping in Physical Channels>

As indicated above, the base station 5 and the UEs 3 of the telecommunication system 1 may be mutually configured to implement one or more enhanced procedures for the allocation of communications resources (e.g., frequency resources) for CORESETs (PDCCHs), PDSCHs and/or PUSCHs, that may include one or more enhancements for frequency hopping and/or frequency interleaving to take account of the impact of SBFD operation.

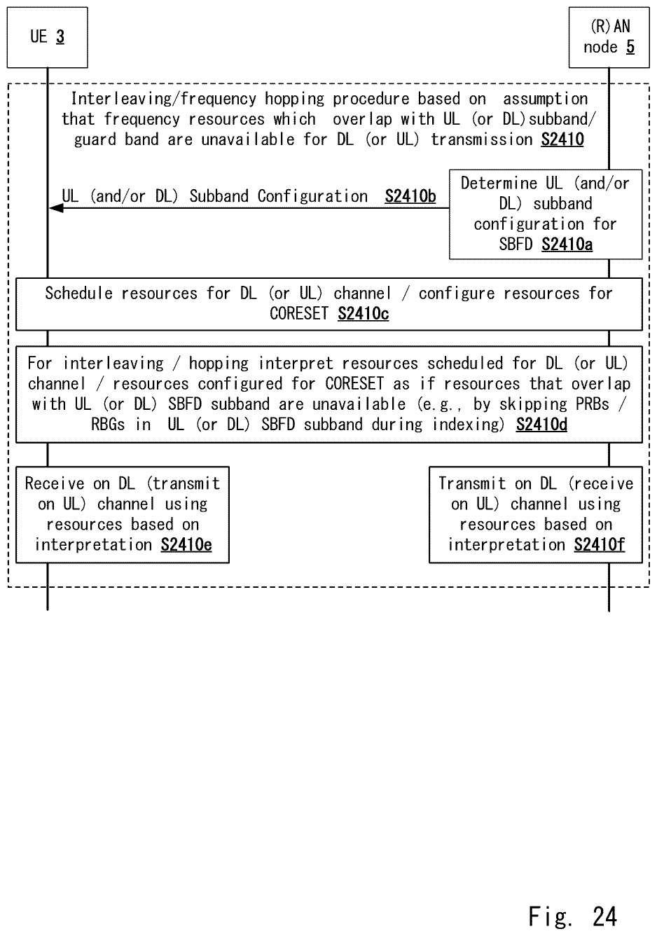

A number of possible procedures for configuring the resource allocation in the context of frequency hopping and/or frequency interleaving (e.g., for VRB to PRB mapping for PUSCH/PDSCH interleaved resource allocation hopping, or for interleaved CORESETs) will now be described in more detail, by way of example only, with reference to FIGS. 24 to 26.

FIG. 24 is a simplified sequence diagram illustrating a procedure for resource configuration for interleaving and/or frequency hopping, in the context of SBFD, that may be employed in the in the telecommunication system 1.

As seen in FIG. 24 the base station 5 and UE 3 may be configured for performing an interleaving/hopping procedure (S2410) based on an assumption that frequency resources (e.g., PRBs or RBGs) which partially/fully overlap with an UL subband/guard band (or a DL subband/guard band) are not available for DL transmission (or UL transmission respectively).

In more detail, the base station 5 determines, at S2410a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S2410b.

The base station 5 then schedules appropriate frequency resources for a DL (or UL) channel (or configures resources for a CORESET) at S2410c (e.g., for a PDSCH, PUSCH or PDCCH CORESET). For the purposes of interleaving/hopping procedures, the scheduled/configured frequency resources are treated as if resources that overlap with UL (or DL) SBFD subband are unavailable/do not exist at S2410d. For example, any PRBs or RBGs that overlap with the SBFD subband/guard band may be ignored and the remaining PRBs/RBGs indexed as if they are contiguous PRBs/RBGs even if they are separated in frequency by the SBFD subband/guard band.

Thus, the UE 3 can, at S2410e, receive on the DL (or transmit on the UL) using frequency resources that are interleaved, or the subject of hopping, based on the interpretation that resources that overlap with UL (or DL) SBFD subband are unavailable/do not exist. Similarly the base station 5 can, at S2410f, transmit on the DL (or receive on the UL) using frequency resources that are interleaved, or the subject of hopping, based on the interpretation that resources that overlap with UL (or DL) SBFD subband are unavailable/do not exist.

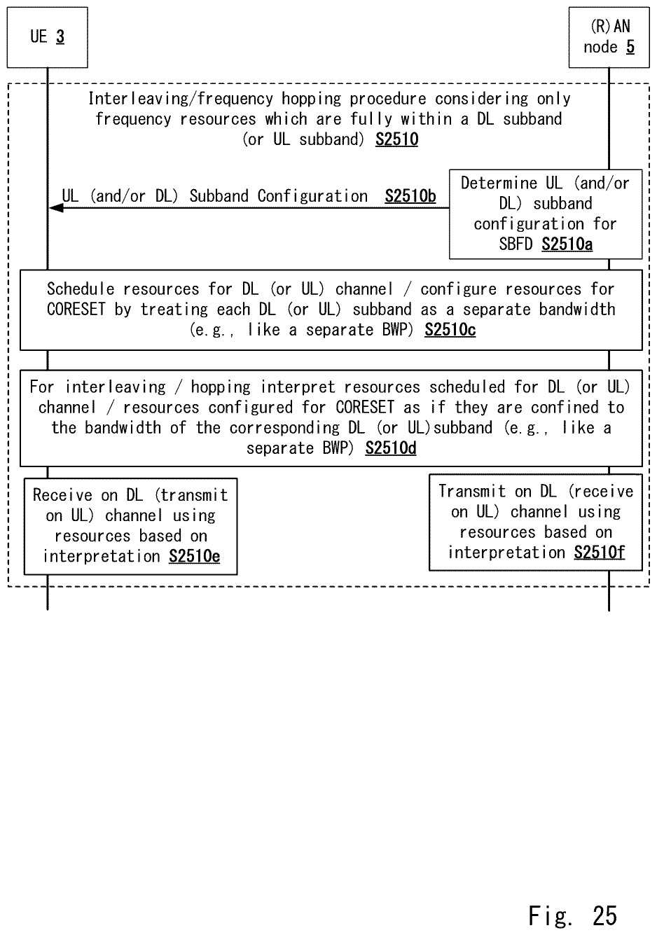

FIG. 25 is a simplified sequence diagram illustrating another procedure for resource configuration for interleaving and/or frequency hopping, in the context of SBFD, that may be employed in the in the telecommunication system 1.

As seen in FIG. 25 the base station 5 and UE 3 may be configured for performing an interleaving/hopping procedure (S2510) based on the assumption that only frequency resources that are fully within a single DL subband (or UL subband) are available.

In more detail, the base station 5 determines, at S2510a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S2510b.

The base station 5 then schedules appropriate frequency resources for a DL (or UL) channel (or configures resources for a CORESET) at S2510c (e.g., for a PDSCH, PUSCH or PDCCH CORESET). When scheduling/configuring these resources the base station 5 effectively treats each DL (or UL) subband as a separate bandwidth/BWP within which any interleaving/frequency hopping is confined. For the purposes of interleaving/hopping procedures, therefore, the scheduled/configured frequency resources are treated as if that DL (or UL) subband is a separate bandwidth/BWP (at S2510d).

Thus, the UE 3 can, at S2510e, receive on the DL (or transmit on the UL) using frequency resources that are interleaved, or the subject of hopping, and that are confined within a corresponding DL SBFD subband (or UL SBFD subband). Similarly the base station 5 can, at S2510f, transmit on the DL (or receive on the UL) using frequency resources that are interleaved, or the subject of hopping, and that are confined within a corresponding DL SBFD subband (or UL SBFD subband).

It can be seen therefore, that in this procedure, each SBFD subband effectively assumes the role of bandwidth part for interleaving/frequency hopping (i.e. interleaving/hopping is performed within the subband). Given that there may be a plurality of subbands for a given transmission direction per symbol, the base station 5/UE 3 may be configured for performing interleaving/frequency hopping procedures independently in each subband of the same direction.

In this case, the selection of which of the plurality of subband to be used for a particular interleaving procedure may be based on an explicit indication provided by the base station 5. The selection of which of the plurality of subband to be used for a particular interleaving procedure may be based on an implicit indication, for example, by deriving the appropriate subband based on which subband a reference frequency resource for transmission is located in. For frequency hopping, the UE 3 may determine the subband to use to be the subband that includes the frequency resources of the first transmission symbol/slot.

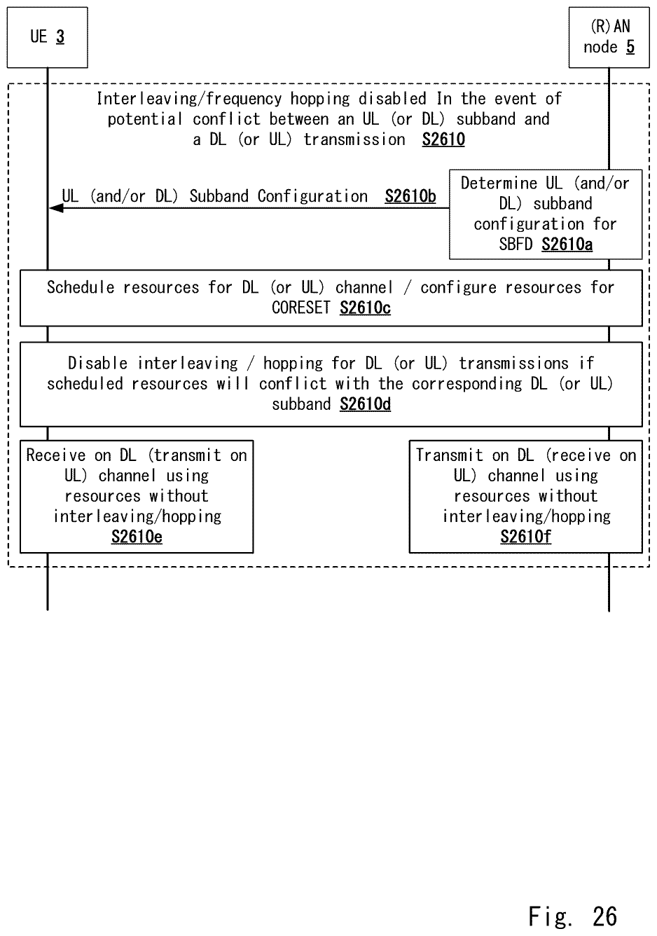

FIG. 26 is a simplified sequence diagram illustrating another procedure for resource configuration for interleaving and/or frequency hopping, in the context of SBFD, that may be employed in the in the telecommunication system 1.

As seen in FIG. 26 the base station 5 and UE 3 may be configured for disabling an interleaving/hopping procedure when the UE 3 is configured with an UL SBFD subband (or DL SBFD subband) in the active BWP, and there is conflict of DL (or UL) transmission with the UL (or DL) subband (S2610).

In more detail, the base station 5 determines, at S2610a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S2610b.

The base station 5 then schedules appropriate frequency resources for a DL (or UL) channel (or configures resources for a CORESET) at S2610c (e.g., for a PDSCH, PUSCH, or PDCCH CORESET). In the event that part of the scheduled resources will conflict with the corresponding DL (or UL) subband interleaving/frequency hopping is disabled (at S2610d).

Thus, the UE 3 can, at S2610e, receive on the DL (or transmit on the UL) using frequency resources without interleaving, or hopping. Similarly the base station 5 can, at S2610f, transmit on the DL (or receive on the UL) using frequency resources without interleaving, or hopping.

It will be appreciated that, in a variation on the procedures described with reference to FIGS. 24 to 26, the base station 5 may be configured to indicate to the UE 3 (e.g. using DCI or an RRC configuration) whether or not to use the corresponding procedure for transmission. For example, if a base station 5 wants to use an UL SBFD subband for DL transmission as well (in absence of UL scheduling), then it can indicate to the UE 3 (e.g. via a scheduling DCI or the like) that the DL transmission shall use an interleaving procedure based on the assumption that the entire BWP's frequency resources are available for interleaving (i.e., that none of the procedures described with reference to FIGS. 24 to 26 are to be used). In one example, the base station may indicate this to the UE as part of another indication which indicates to the UE to use UL SBFD subband for DL transmission.

Moreover, where the base station 5 and UE 3 may be configured to be capable of implementing more than one of the procedures described with reference to FIGS. 24 to 26, the base station 5 may be configured to indicate (e.g. using DCI or an RRC configuration) which of the procedures to use (e.g., for interleaving).

<Interleaving/Frequency Hopping for Transmissions in Time Domain Resources that Include Both SBFD and Non-SBFD Symbol/Slots>

While the procedures described with reference to FIGS. 24 to 26 above may be applied in respect of single slot transmission or multi-slot transmission in which all symbols or slots are configured for SBFD, it is possible that single slot transmissions may take place in slots that include both SBFD and non-SBFD symbols and multi-slot transmission may be in a set of slots that include both SBFD and non-SBFD symbols/slots.

There are a number of ways in which such mixed SBFD/non-SBFD slot/symbol scenarios may be dealt with in the telecommunication system 1.

For example, in a first option, in the event that single slot transmissions are to take place in slots that include both SBFD and non-SBFD symbols, or multi-slot transmissions are to take place in a set of slots that include both SBFD and non-SBFD symbols/slots, then any of the procedures described with reference to FIGS. 24 to 26 above may be applied in respect of all symbols/slots regardless of whether they are SBFD slots/symbols or non-SBFD slots/symbols.

Alternatively, in a second option, in the event that single slot transmissions are to take place in slots that include both SBFD and non-SBFD symbols, or multi-slot transmissions are to take place in a set of slots that include both SBFD and non-SBFD symbols/slots, then any of the procedures described with reference to FIGS. 24 to 26 above may be applied in respect of SBFD symbols/slots only.

The base station 5 may indicate to the UE 3, whether the UE 3 should use a legacy interleaving/hopping procedure or one of the first and second options.

For example, if the base station 5 has scheduled a DL transmission which overlaps (partly or fully) with configured UL SBFD subband resources, and if network wants to use the UL subband resources for the DL transmissions even for SBFD symbols/slots, then it may indicate to the UE 3 to use a legacy procedure for all slots/symbols. Otherwise, it may indicate to UE to use one of the first and second options.

In another alternative, the base station 5 may indicate, to the UE 3, the specific slots/symbols where the UE is to use one of the procedures described with reference to FIGS. 24 to 26. In other slots/symbols, the UE 3 may, by default, use a legacy procedure.

It will also be appreciated that the first or second option may be selected based on whether or not the first slot/symbol of a transmission contains an UL subband/DL subband or not (e.g., the first option may be used where the first slot/symbol contains an UL subband/DL subband and the second option may be used where the first slot/symbol does not contain an UL subband/DL subband).

### <Multi-Slot UL/DL Transmission Including Both SBFD and Non-SBFD Slots>

As indicated above, the base station 5 and the UEs 3 of the telecommunication system 1 may be mutually configured to implement one or more enhanced procedures that take account of the possibility that multi-slot UL/DL transmission may include both SBFD and non-SBFD slots. In particular, the telecommunication system 1 may implement one or more enhanced procedures, for multi-slot UL/DL transmission, that govern the extent to which UL/DL transmission, which spans both SBFD and non-SBFD slots/symbols, should be considered valid and (hence allowed).

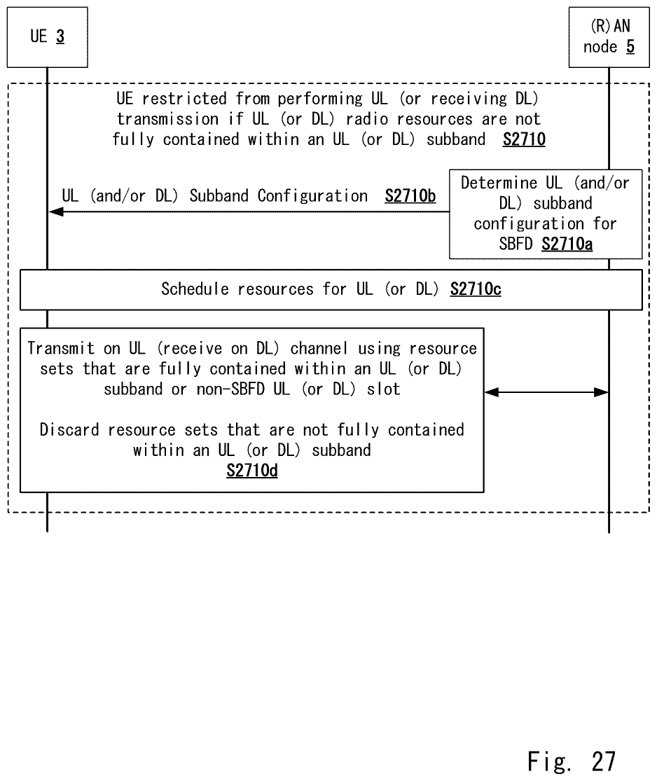

A number of possible procedures for multi-slot UL/DL transmission will now be described in more detail, by way of example only, with reference to FIGS. 27 to 34.

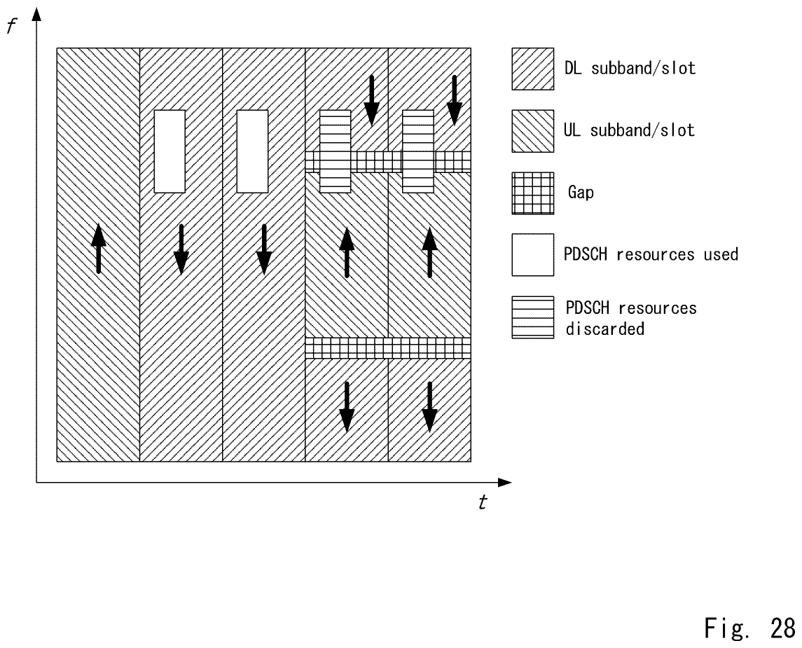

FIG. 27 is a simplified sequence diagram illustrating a procedure for multi-slot UL/DL transmission that may be employed in the in the telecommunication system 1. FIG. 28 is a simplified time frequency diagram showing an illustrative example of an application of the procedure of FIG. 27 for PDSCH transmissions.

As seen in FIG. 27 the UE 3 may be restricted, during multi-slot transmission/reception from performing UL (or receiving DL) transmission if UL (or DL) radio resources are not fully contained within an UL (or DL) subband (S2710).

In more detail, the base station 5 determines, at S2710a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S2710b.

The base station 5 then schedules appropriate frequency resources for an UL channel (e.g., a PUSCH) (or DL channel (e.g., a PDSCH)) at S2710c.

The UE 3 then, at S2710d, transmits on the UL channel (or receives on the DL channel) if one or more corresponding resource sets are fully contained within an UL (or DL) subband or within a non-SBFD UL (or DL) slot. However, the UE 3 does not transmit on the UL channel (or receive on the DL channel) if one or more corresponding resource sets are not fully contained within an UL (or DL) subband (e.g., in an SBFD slot in which one or more resource sets extend into both an UL and a DL subband (and/or associated guard band)).

Referring to FIG. 28, for example, it can be seen that in the first two (non-SBFD) DL slots the PDSCH resources are used for PDSCH transmission/reception but, in the next two (SBFD) slots the PDSCH resources are effectively discarded because they overlap with an UL subband configured for SBFD.

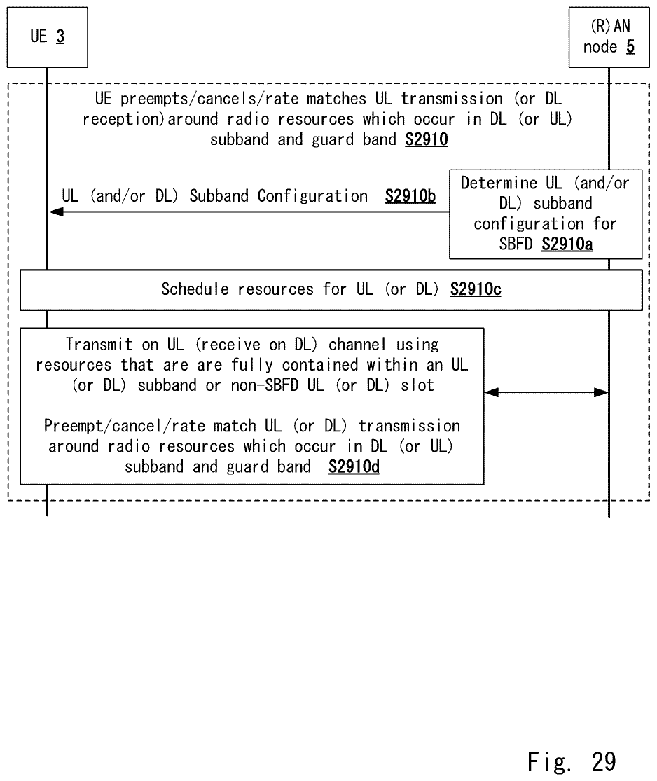

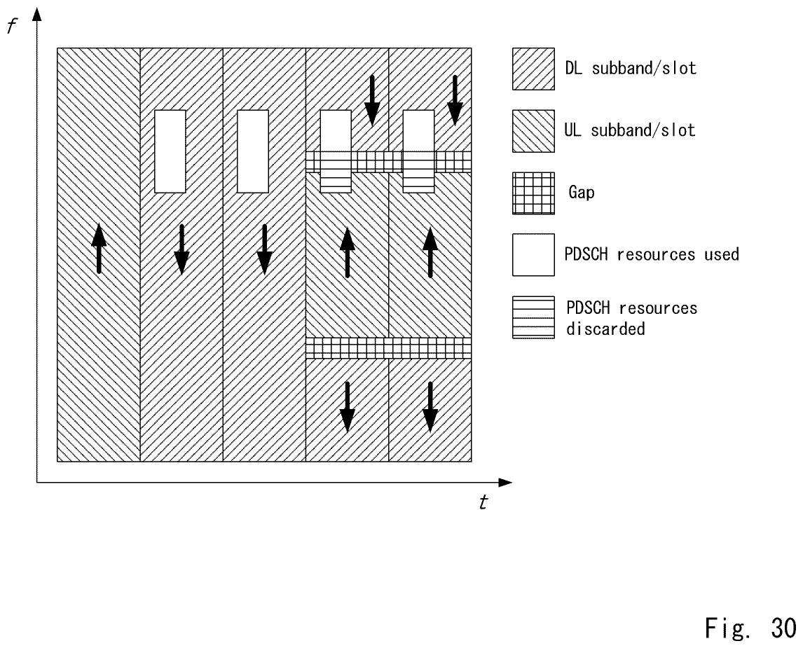

FIG. 29 is a simplified sequence diagram illustrating another procedure for multi-slot UL/DL transmission that may be employed in the in the telecommunication system 1. FIG. 30 is a simplified time frequency diagram showing an illustrative example of an application of the procedure of FIG. 29 for PDSCH transmissions.

As seen in FIG. 29 the UE 3 may UE pre-empt/cancel/rate match UL transmission (or DL reception) around radio resources which occur in a DL (or UL) subband and/or guard band (S2910).

In more detail, the base station 5 determines, at S2910a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S2910b.

The base station 5 then schedules appropriate frequency resources for an UL channel (e.g., a PUSCH) (or DL channel (e.g., a PDSCH)) at S2910c.

The UE 3 then, at S2910d, transmits on the UL channel (or receives on the DL channel) if one or more corresponding resource sets are fully contained within an UL (or DL) subband or within a non-SBFD UL (or DL) slot. The UE 3 transmits on the UL channel (or receives on the DL channel) using any part of one or more resource sets that are within an UL (or DL) subband, but avoids transmission on the UL channel (or receiving on the DL channel) using any part of one or more resource sets that are not contained within the UL (or DL) subband (i.e., in an SBFD slot), by appropriate pre-emption/cancellation/rate matching of the UL (or DL) transmission around those resources.

It will be appreciated that rate matching may be possible for the case when different transport blocks are transmitted over different slots. For repetition, pre-emption/cancellation of radio resources is applicable.

Referring to FIG. 30, for example, it can be seen that in the first two (non-SBFD) DL slots the PDSCH resources are used for PDSCH transmission/reception. In the next two (SBFD) slots the PDSCH resources that do not overlap with the UL subband and guard band are used, whereas the PDSCH resources that overlap with the UL subband and guard band are effectively discarded.

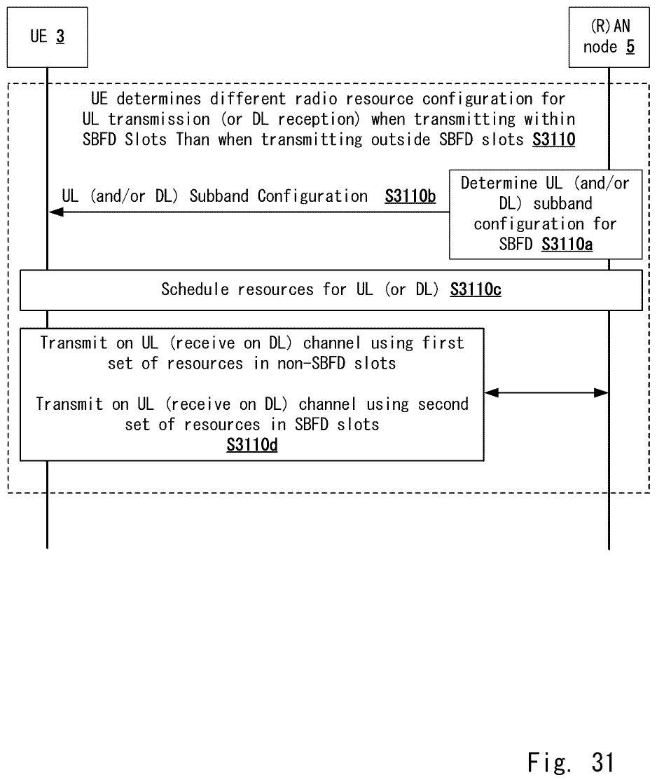

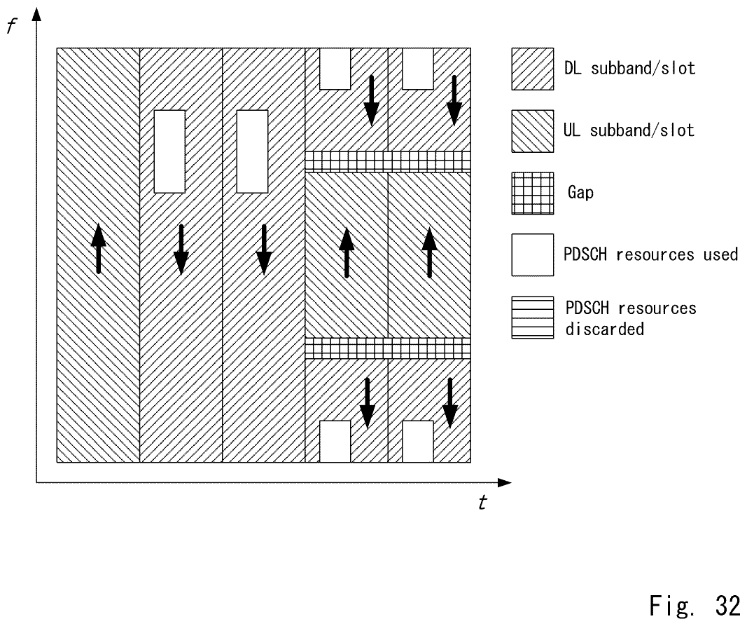

FIG. 31 is a simplified sequence diagram illustrating another procedure for multi-slot UL/DL transmission that may be employed in the in the telecommunication system 1. FIG. 32 is a simplified time frequency diagram showing an illustrative example of an application of the procedure of FIG. 31 for PDSCH transmissions.

As seen in FIG. 31 the UE 3 may determine a different radio resource configuration for UL transmission (or DL reception) when transmitting within SBFD slots than when transmitting outside SBFD slots (S3110).

In more detail, the base station 5 determines, at S3110a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S3110b.

The base station 5 then schedules appropriate frequency resources for an UL channel (e.g., a PUSCH) (or DL channel (e.g., a PDSCH)) at S3110c.

The UE 3 then, at S3110d, transmits on the UL channel (or receives on the DL channel) using a first set of resources in non-SBFD slots. The UE 3 transmits on the UL channel (or receives on the DL channel) using a second (different) set of resources, in SBFD slots, that do not overlap with a corresponding DL (or UL) SBFD subband.

The UE 3 may determine the different radio resource configuration for UL (or DL) transmissions within SBFD slots based on a pre-defined rule. For example, the pre-defined rule may be based on a recalculation of frequency resources based on updated PRB/RBG numbering that takes account of the presence of DL subband (and/or UL subband) resources.

It will be appreciated that this approach may be applicable only if allocated frequency resources for transmission are less than a configured value, or less than a threshold fraction of the subband bandwidth.

Referring to FIG. 32, for example, it can be seen that in the first two (non-SBFD) DL slots a first set of PDSCH resources are used for PDSCH transmission/reception. In the next two (SBFD) slots a second set of PDSCH resources, that do not overlap with the UL subband and guard band, are used (that, in the illustrated example, include the resources of two DL subbands).

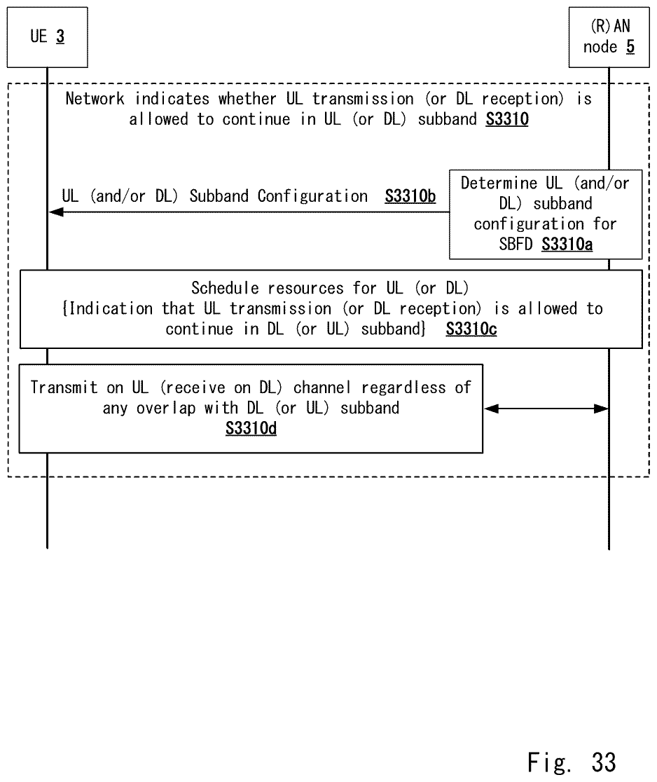

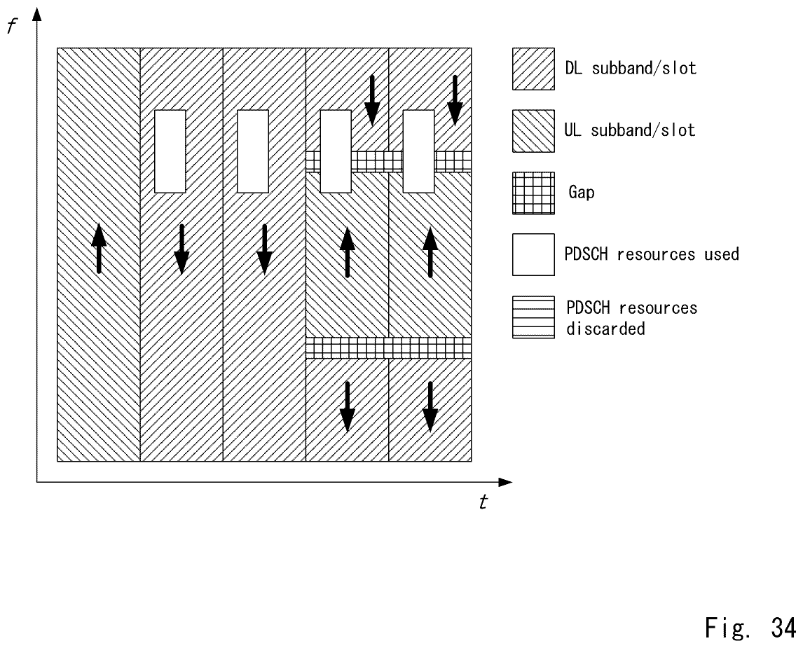

FIG. 33 is a simplified sequence diagram illustrating another procedure for multi-slot UL/DL transmission that may be employed in the in the telecommunication system 1. FIG. 34 is a simplified time frequency diagram showing an illustrative example of an application of the procedure of FIG. 33 for PDSCH transmissions.

As seen in FIG. 33 the base station 5 may indicates, to the UE 3, whether UL transmission (or DL reception) is allowed to continue in the UL (or DL) subband (S3310).

In more detail, the base station 5 determines, at S3310a, an SBFD subband configuration. The SBFD subband configuration may effectively configure an UL subband, in a slot configured for DL (and hence one or more DL subbands for SBFD also). The SBFD subband configuration may effectively configure a DL subband, in a slot configured for UL (and hence one or more UL subbands for SBFD also). The SBFD subband configuration is provided to the UE 3 at S3310b.

subband configuration is provided to the UE 3 at S3310b.

The base station 5 then schedules appropriate frequency resources for an UL channel (e.g., a PUSCH) (or DL channel (e.g., a PDSCH)) at S3310c. The base station 5 also provides an indication that UL transmission (and/or DL reception) is allowed to continue in a DL (and/or UL) subband. The base station may indicate to the UE, by absence of the given indication or by providing a different value of the indication, to use one of the procedures described with reference to FIGS. 28 to 32.

The UE 3 then, at S3310d, transmits on the UL channel (or receives on the DL channel) using the scheduled resources in both non-SBFD slots and SBFD slots regardless of any overlap with the DL (or UL) subband.

Referring to FIG. 34, for example, it can be seen that in the first two (non-SBFD) DL slots the PDSCH resources that are used for PDSCH transmission/reception are the same as the set of PDSCH resources that are used in the next two (SBFD) slots regardless of the overlap with the UL subband.

It will be appreciated that while, in the procedure of FIG. 33, the indication is shown as being part of same signalling (e.g. a DCI) that scheduled the UL (or DL) transmission, the indication could be provided as part of a different control message.

It will also be appreciated that, while the UE may use same set of frequency resource in both SBFD and non-SBFD slots (as illustrated in the examples of FIG. 34), the base station 5 may indicate a first set of radio resources to be used for SBFD slots and a second set of radio resources to be used for non-SBFD slots.

Moreover, in a variation of this procedure, the base station 5 may indicate a subset of SBFD slots/symbols for which UL transmission (or DL reception) is allowed in DL (or UL) SBFD subbands.

It will also be appreciated that a different procedure from those described with reference to FIGS. 27 to 34, may be selected dependent on the type of radio resource allocation and/or type of transmission (e.g., DL or UL). For example, for radio resource allocation Type-0, one of the procedures described with reference to FIGS. 27 to 30 may be used, while for Type-1 allocation the procedure described with reference to FIGS. 31 and 32 may be used.

It will also be appreciated that a different procedure from those described with reference to FIGS. 27 to 34, may be selected dependent on whether the first slot of transmission is an SBFD slot (e.g., containing an UL (or DL) subband). For example, if a first slot of the transmission is non-SBFD then the procedure described with reference to FIGS. 27 and 28 may be used otherwise, the procedure described with reference to FIGS. 31 and 32 may be used.

It will also be appreciated that a different procedure from those described with reference to FIGS. 27 to 34, may be selected dependent on whether different slots contain the same or different transport blocks. For example, the procedure described with reference to FIGS. 27 and 28 may be used for the case when different transport blocks are transmitted, whereas the procedure described with reference to FIGS. 29 and 30 may be used may be used for the case of the same transport blocks.

### <User Equipment>

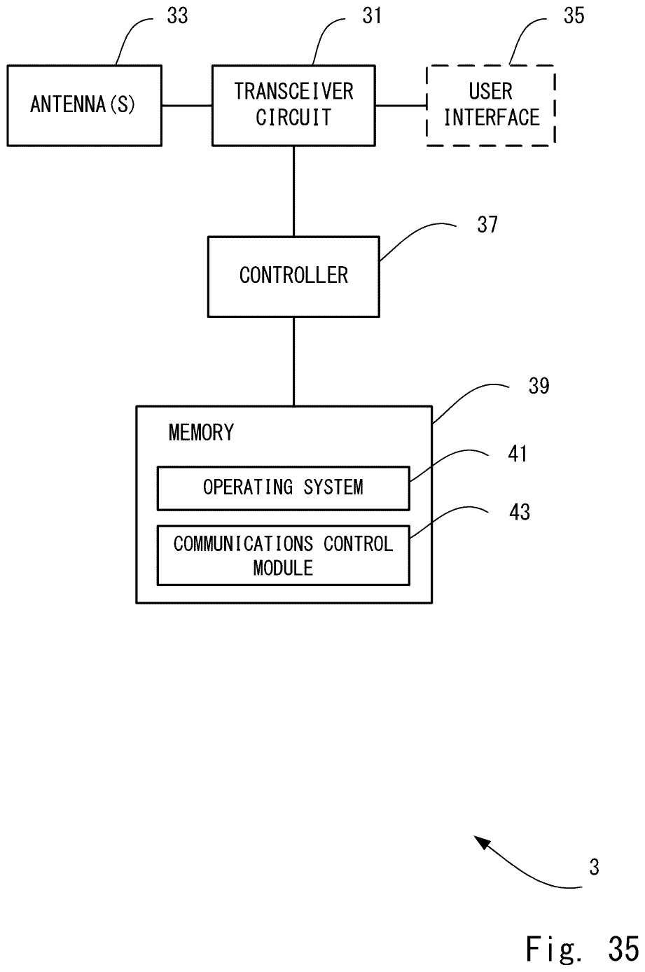

FIG. 35 is a schematic block diagram illustrating the main components of a UE 3 as shown in FIG. 5.

As shown, the UE 3 has a transceiver circuit 31 that is operable to transmit signals to and to receive signals from a base station 5 via one or more antenna 33 (e.g., comprising one or more antenna elements). The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the telecommunications network or from a removable data storage device (RMD), for example.

The controller 37 is configured to control overall operation of the UE 3 by, in this example, program instructions or software instructions stored within memory 39. As shown, these software instructions include, among other things, an operating system 41, and a communications control module 43.

The communications control module 43 is operable to control the communication between the UE 3 and its one or more serving base stations 5 (and other communication devices connected to the base station 5, such as further UEs and/or core network nodes). The communications control module 43 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 43 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 43 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like.

### <Base Station>

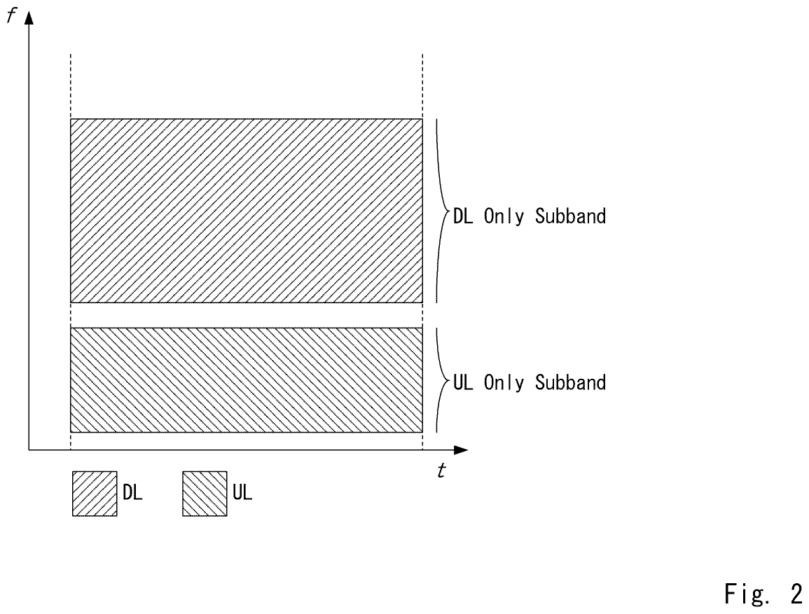

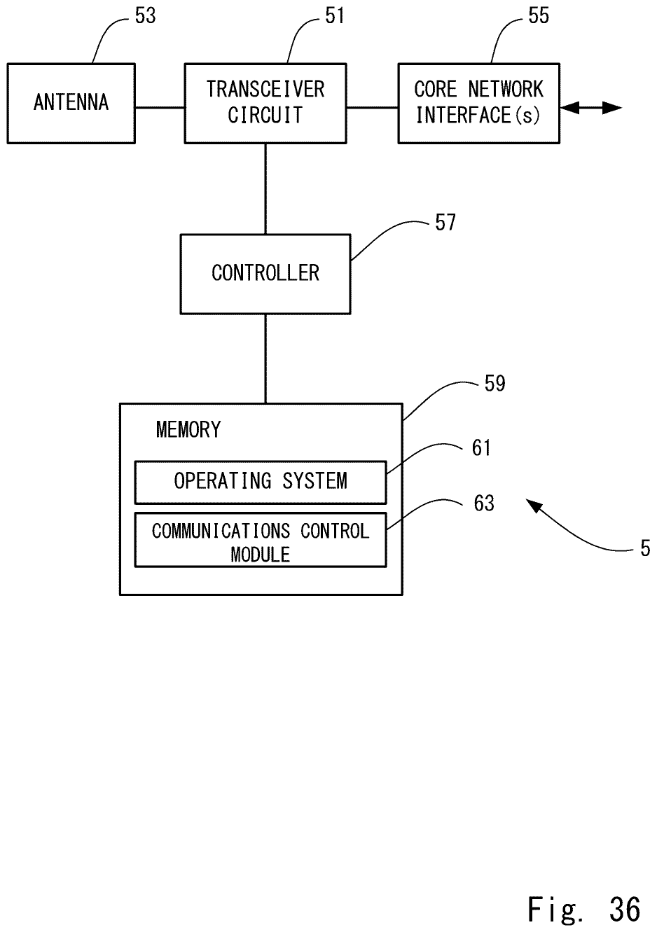

FIG. 36 is a schematic block diagram illustrating the main components of the base station 5 for the telecommunication system 1 shown in FIG. 2. As shown, the base station 5 has a transceiver circuit 51 for transmitting signals to and for receiving signals from the communication devices (such as UEs 3) via one or more antenna 53 (e.g. a single or multi-panel antenna array/massive antenna), and a core network interface 55 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 57 to control the operation of the base station 5. The controller 57 is associated with a memory 59. Software may be pre-installed in the memory 59 and/or may be downloaded via the telecommunication system 1 or from a removable data storage device (RMD), for example. The controller 57 is configured to control the overall operation of the base station 5 by, in this example, program instructions or software instructions stored within memory 59.

As shown, these software instructions include, among other things, an operating system 61 and a communications control module 63. The communications control module 63 is operable to control the communication between the base station 5 and UEs 3 and other network entities that are connected to the base station 5. The communications control module 63 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 63 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 63 is responsible for managing full duplex (e.g., SBFD) communication including, where appropriate, the segregation of UL and DL communication via different physical antenna elements. The communications control module 43 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like.

### <Modifications and Alternatives>

A detailed example embodiment has been described above. As those skilled in the art will appreciate, a number of modifications and alternatives can be made to the above example embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following Table 3. This list is not exhaustive and is intended to be indicative of some examples of machine type communication applications.

TABLE 3

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

This application is based upon and claims the benefit of priority from UK patent application No. 2214820.9, filed on Oct. 7, 2022, the disclosure of which is incorporated herein in its entirety by reference.

### <Supplementary Notes>

The whole or part of the example Aspects disclosed above can be described as, but not limited to, the following supplementary notes.

### (Supplementary Note 1)

A method performed by an access network node, the method comprising:
transmitting, to a user equipment (UE), first information for configuring at least one time domain resource with at least two frequency regions, wherein the at least two frequency regions include at least one downlink (DL) frequency region for DL communication and at least one uplink (UL) frequency region for UL communication; and
communicating with the UE, in the at least one time domain resource with at least two frequency regions, based on second information,
wherein the second information indicates at least one of:
at least one search space set;
at least one frequency resource set scheduled for DL communication to the UE;
at least one control resource set (CORESET); or
at least one frequency resource set scheduled for UL communication from the UE; and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the UE; or
between the at least one DL frequency region and the at least one frequency resource set scheduled for UL communication from the UE.

### (Supplementary Note 2)

The method according to supplementary note 1, wherein
the second information includes common search space (CSS) configuration information for configuring at least one CSS set; and
at least one of the first information and the CSS configuration information is configured to avoid overlap between the at least one UL frequency region and the at least one CSS set.

### (Supplementary Note 3)

The method according to supplementary note 2, wherein
the second information includes resource configuration information for configuring at least one frequency resource set scheduled for communication of DL control information to the UE in the CSS set, and
the resource configuration information is configured to avoid overlap between at least one resource of the at least one UL frequency region required for a UL transmission and the at least one frequency resource set scheduled for communication of DL control information to the UE, regardless of any overlap between the at least one UL frequency region and the at least one CSS set.

### (Supplementary Note 4)

The method according to supplementary note 2 or 3, wherein
the CSS configuration information is configured to:
configure a first CSS set for use by a UE that supports configuration of the at least one time domain resource with the at least two frequency regions, and configure a second CSS set for use by a UE that does not support configuration of the at least one time domain resource with the at least two frequency regions, and
at least one of the first information and CSS configuration information is configured to avoid overlap between the at least one UL frequency region and the first CSS set regardless of any overlap between the at least one UL frequency region and the second CSS set.

### (Supplementary Note 5)

The method according to any one of supplementary notes 2 to 4, wherein
at least one of the first information and second information is configured to avoid the overlap in respect of all physical downlink control channel (PDCCH) transmissions in the at least one CSS set.

### (Supplementary Note 6)

The method according to any one of supplementary notes 2 to 4, wherein
at least one of the first information and second information is configured to avoid the overlap in respect of physical downlink control channel (PDCCH) transmissions associated with broadcast channels or other PDCCH transmissions to multiple UEs.

### (Supplementary Note 7)

The method according to any one of supplementary notes 2 to 4, wherein
at least one of the first information and second information is configured to avoid the overlap in respect of all physical downlink control channel (PDCCH) transmissions except PDCCH transmissions associated with a cell radio network temporary identifier (C-RNTI).

### (Supplementary Note 8)

The method according to any one of supplementary notes 2 to 4, wherein
at least one of the first information and second information is configured to avoid the overlap in respect of all physical downlink control channel (PDCCH) transmissions that are for receipt by both UEs that support configuration of the at least one time domain resource with the at least two frequency regions, and UEs that do not support configuration of the at least one time domain resource with the at least two frequency regions.

### (Supplementary Note 9)

The method according to any one of supplementary notes 1 to 8, wherein
the second information includes CORESET configuration information for configuring at least one CORESET, and
at least one of the first information and CORESET configuration information is configured to avoid overlap between the at least one UL frequency region and the at least one CORESET.

### (Supplementary Note 10)

The method according to supplementary note 9, wherein
the CORESET configuration information is configured to:
configure a first CORESET for use by a UE in the at least one time domain resource with the at least two frequency regions, and to
configure a second CORESET for use by a UE in at least one other time domain resource which is configured for DL communication only.

### (Supplementary Note 11)

The method according to supplementary note 10, wherein
the first CORESET is used for physical downlink control channel (PDCCH) transmission in the at least one time domain resource with the at least two frequency regions in a case where any PDCCH candidate of the second CORESET overlaps with the at least one uplink (UL) frequency region.

### (Supplementary Note 12)

The method according to supplementary note 10, wherein
the at least one time domain resource with the at least two frequency regions includes at least one symbol in which the at least two frequency regions are configured, and
the first CORESET is used for physical downlink control channel (PDCCH) transmission in the at least one time domain resource with the at least two frequency regions in a case where any PDCCH candidate of the second CORESET overlaps at least in time with the at least one symbol.

### (Supplementary Note 13)

The method according to supplementary note 10, wherein
the at least one time domain resource with the at least two frequency regions includes at least one symbol in which the at least two frequency regions are configured, and
the first CORESET is used for physical downlink control channel (PDCCH) transmission in the at least one time domain resource with the at least two frequency regions in a case where a PDCCH search space associated with the second CORESET overlaps at least in time with the at least one symbol.

### (Supplementary Note 14)

The method according to supplementary note 10, wherein
the at least one time domain resource with the at least two frequency regions includes at least one symbol in which the at least two frequency regions are configured, and
the first CORESET is used for physical downlink control channel (PDCCH) transmission in any slot in which the at least one symbol is included.

### (Supplementary Note 15)

The method according to supplementary note 10, wherein
the first CORESET is used for physical downlink control channel (PDCCH) transmission in the at least one time domain resource with the at least two frequency regions in a case where all PDCCH candidates of the second CORESET overlap with the at least one uplink (UL) frequency region.

### (Supplementary Note 16)

The method according to any one of supplementary notes 10 to 15, wherein
the at least one CORESET correspond to at least one search space the at least one time domain resource with the at least two frequency regions and at least one search space the at least one other time domain resource which is configured for DL communication only.

### (Supplementary Note 17)

The method according to any one of supplementary notes 1 to 16, wherein
the second information includes information for configuring frequency domain resources for at least one of:
the at least one frequency resource set scheduled for DL communication to the UE;
the at least one control resource set (CORESET); or
the at least one frequency resource set scheduled for UL communication from the UE, and
the frequency domain resources are configured based on interleaving and/or frequency hopping.

### (Supplementary Note 18)

The method according to supplementary note 17, wherein
the frequency domain resources are configured based on a modified interleaving procedure and/or frequency hopping procedure in which:
frequency domain resources for the DL communication, or for the at least one CORESET, that overlap with the at least one UL frequency region are treated as being unavailable; or
frequency domain resources for the UL communication that overlap with the at least one DL frequency region are treated as being unavailable.

### (Supplementary Note 19)

The method according to supplementary note 17, wherein
the frequency domain resources are configured based on a modified interleaving procedure and/or frequency hopping procedure in which:
frequency domain resources for the DL communication, or for the at least one CORESET, are restricted to being within a single DL frequency region of the at least one DL frequency region; or
frequency domain resources for the UL communication are restricted to being within a single UL frequency region of the at least one UL frequency region.

### (Supplementary Note 20)

The method according to supplementary note 17, wherein
the interleaving and/or frequency hopping is disabled in a case where the UE is configured with the at least one time domain resource with at least two frequency regions, in an active bandwidth part, and
the interleaving and/or frequency hopping would otherwise cause a conflict between UL communication and the at least one DL frequency region, or between DL communication and the at least one UL frequency region.

### (Supplementary Note 21)

The method according to any one of supplementary notes 17 to 20, further comprising:
transmitting, to the UE, third information for indicating whether or not a modified interleaving/hopping procedure should be used for configuring the frequency domain resources.

### (Supplementary Note 22)

The method according to supplementary note 21, wherein
in a case where the third information indicates that a modified interleaving/hopping procedure should be used, the third information indicates which of a plurality of different modified interleaving/hopping procedure should be used.

### (Supplementary Note 23)

The method according to any one of supplementary notes 18 to 20, wherein
in a case where communication using the frequency domain resources is to take place in both the at least one time domain resource with the at least two frequency regions and at least one other time domain resource that is configured for UL or DL communication only, the modified interleaving procedure and/or frequency hopping procedure is used, or interleaving/frequency hopping is disabled, for all time domain resources in which communication using the frequency domain resources is to take place.

### (Supplementary Note 24)

The method according to any one of supplementary notes 18 to 20, wherein
in a case where communication using the frequency domain resources is to take place in both the at least one time domain resource with at least two frequency regions and at least one other time domain resource that is configured for UL or DL communication only, the modified interleaving procedure and/or frequency hopping procedure is used, or interleaving/frequency hopping is disabled, for the at least one time domain resource with at least two frequency regions in which communication using the frequency domain resources is to take place.

### (Supplementary Note 25)

The method according to any one of supplementary notes 18 to 20, further comprising:
in a case where communication using the frequency domain resources is to take place in both the at least one time domain resource with at least two frequency regions and at least one other time domain resource that is configured for UL or DL communication only, transmitting, to the UE, an indication of whether the modified interleaving procedure and/or frequency hopping procedure should be used, or interleaving/frequency hopping should be disabled:
for all time domain resources in which communication using the frequency domain resources is to take place; or
for only the at least one time domain resource with at least two frequency regions in which communication using the frequency domain resources is to take place.

### (Supplementary Note 26)

A method performed by a user equipment (UE), the method comprising:
receiving, from an access network node, first information for configuring at least one time domain resource with at least two frequency regions, wherein the at least two frequency regions include at least one downlink (DL) frequency region for DL communication and at least one uplink (UL) frequency region for UL communication;
communicating with the access network node, in the at least one time domain resource with at least two frequency regions, based on second information, wherein the second information is adapted to configure at least one of:
at least one search space set; at least one frequency resource set scheduled for DL communication from the access network node;
at least one control resource set (CORESET); or
at least one frequency resource set scheduled for UL communication to the access network node; and
determining, based on at least one of the first information and the second information, at least one set of resources for at least one of:
monitoring the at least one search space set; DL communication in the at least one frequency resource set scheduled for DL communication;
monitoring the at least one CORESET; or
UL communication in the at least one frequency resource set scheduled for UL communication;
wherein, the at least one set of resources is determined by the UE to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

### (Supplementary Note 27)

The method according to supplementary note 26, wherein
the UE is scheduled for DL communication, or UL communication, with the access network node in a plurality of time resources including both the at least one time domain resource with the at least two frequency regions, and at least one other time domain resource which is configured for DL communication only, or for UL communication only.

### (Supplementary Note 28)

The method according to supplementary note 27, further comprising:
performing the DL communication, or the UL communication, using the at least one set of resources for communication with the access network node in the at least one other time domain resource; and
discarding the at least one set of resources for the DL communication, or the UL communication, in the at least one time domain resource with the at least two frequency regions, to avoid overlap between the at least one DL frequency region and the UL communication or between the at least one UL frequency region and the DL communication.

### (Supplementary Note 29)

The method according to supplementary note 27, further comprising:
performing the DL communication, or the UL communication, using the at least one set of resources for communication with the access network node in the at least one other time domain resource; and
pre-empting, cancelling, or rate-matching around a part of the at least one set of resources in the at least one time domain resource with the at least two frequency regions, to avoid overlap between the at least one DL frequency region and the UL communication or between the at least one UL frequency region and the DL communication.

### (Supplementary Note 30)

The method according to supplementary note 27, further comprising:
performing the DL communication, or the UL communication, using the at least one set of resources for communication with the access network node in the at least one other time domain resource; and
performing the DL communication, or the UL communication, using at least one other set of resources for communication with the access network node in the at least one time domain resource with the at least two frequency regions, to avoid overlap between the at least one DL frequency region and the UL communication or between the at least one UL frequency region and the DL communication.

### (Supplementary Note 31)

The method according to supplementary note 30, further comprising:
determining the at least one other set of resources based on a pre-defined rule.

### (Supplementary Note 32)

The method according to supplementary note 27, further comprising:
receiving from the access network node third information indicating whether the DL communication is permitted in the at least one DL frequency region of the at least one time domain resource with the at least two frequency regions, or
whether the UL communication is permitted in the at least one UL frequency region of the at least one time domain resource with the at least two frequency regions.

### (Supplementary Note 33)

The method according to supplementary note 32, wherein
the third information includes information indicating a first set of radio resources for communication in the at least one time domain resource with the at least two frequency regions, and a second set of radio resources for communication in the at least one other time domain resource.

### (Supplementary Note 34)

The method according to supplementary note 32, wherein
the at least one time domain resource with at least two frequency regions includes a plurality of time domain resources with the at least two frequency regions, and
the third information includes information indicating a subset of the plurality time domain resources with the at least two frequency regions for which DL communication is permitted in at least one DL frequency region, or UL communication is permitted in at least one UL frequency region.

### (Supplementary Note 35)

An access network node comprising:
means for transmitting, to a user equipment (UE), first information for configuring at least one time domain resource with at least two frequency regions, wherein the at least two frequency regions include at least one downlink (DL) frequency region for DL communication and at least one uplink (UL) frequency region for UL communication; and
means for communicating with the UE, in the at least one time domain resource with at least two frequency regions, based on second information,
wherein the second information is adapted to configure at least one of:
at least one search space set;
at least one frequency resource set scheduled for DL communication to the UE;
at least one control resource set (CORESET); or
at least one frequency resource set scheduled for UL communication from the UE; and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the UE; or
between the at least one DL frequency region and the at least one frequency resource set scheduled for UL communication from the UE.

### (Supplementary Note 36)

A user equipment (UE) comprising:
means for receiving, from an access network node, first information for configuring at least one time domain resource with at least two frequency regions, wherein the at least two frequency regions include at least one downlink (DL) frequency region for DL communication and at least one uplink (UL) frequency region for UL communication;
means for communicating with the access network node, in the at least one time domain resource with at least two frequency regions, based on second information,
wherein the second information is adapted to configure at least one of:
at least one search space set;
at least one frequency resource set scheduled for DL communication from the access network node;
at least one control resource set (CORESET); or
at least one frequency resource set scheduled for UL communication to the access network node; and
means for determining, based on at least one of the first information and the second information, at least one set of resources for at least one of:
monitoring the at least one search space set;
DL communication in the at least one frequency resource set scheduled for DL communication;
monitoring the at least one CORESET; or
UL communication in the at least one frequency resource set scheduled for UL communication;
wherein, the at least one set of resources is determined by the UE to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

### REFERENCE SIGNS LIST

1 telecommunication system
3 UE
5 base station (node)
7 core network
9 cell
10 CPFs
10-1 AMF
10-2 SMF
11 UPFs
20 external data network

What is claimed is:

1-36. (canceled)

37. A method performed by a mobile device, the method comprising:
receiving, from an access network node, first information for configuring at least one time domain resource with at least two frequency regions, wherein the at least two frequency regions include at least one downlink (DL) frequency region for DL communication and at least one uplink (UL) frequency region for UL communication;
communicating with the access network node, in the at least one time domain resource with at least two frequency regions, based on second information,
wherein the second information includes information for configuring frequency resources for at least one of:
at least one search space set;
at least one frequency resource set scheduled for DL communication from the access network node;
at least one control resource set (CORESET); or
at least one frequency resource set scheduled for UL communication to the access network node,
wherein the frequency domain resources are configured based on interleaving and/or frequency hopping, and the method further comprises:
determining, based on at least one of the first information and the second information, at least one set of resources for at least one of:
monitoring the at least one search space set; DL communication in the at least one frequency resource set scheduled for DL communication;
monitoring the at least one CORESET; or
UL communication in the at least one frequency resource set scheduled for UL communication,
wherein, the at least one set of resources is determined by the mobile device to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

38. The method according to claim 37, wherein
the frequency domain resources are configured based on a modified interleaving procedure and/or frequency hopping procedure in which:
frequency domain resources for the DL communication, or for the at least one CORESET, that overlap with the at least one UL frequency region are treated as being unavailable; or
frequency domain resources for the UL communication that overlap with the at least one DL frequency region are treated as being unavailable.

39. The method according to claim 37, wherein
the frequency domain resources are configured based on a modified interleaving procedure and/or frequency hopping procedure in which:
frequency domain resources for the DL communication, or for the at least one CORESET, are restricted to being within a single DL frequency region of the at least one DL frequency region; or
frequency domain resources for the UL communication are restricted to being within a single UL frequency region of the at least one UL frequency region.

40. The method according to claim 37, wherein
the interleaving and/or frequency hopping is disabled in a case where the mobile device is configured with the at least one time domain resource with at least two frequency regions, in an active bandwidth part, and
the interleaving and/or frequency hopping would otherwise cause a conflict between UL communication and the at least one DL frequency region, or between DL communication and the at least one UL frequency region.

41. The method according to claim 37, further comprising:
receiving, from the access network node, third information for indicating whether or not a modified interleaving/hopping procedure should be used for configuring the frequency domain resources.

42. The method according to claim 41, wherein
in a case where the third information indicates that a modified interleaving/hopping procedure should be used, the third information indicates which of a plurality of different modified interleaving/hopping procedure should be used.

43. The method according to claim 38, wherein
in a case where communication using the frequency domain resources is to take place in both the at least one time domain resource with the at least two frequency regions and at least one other time domain resource that is configured for UL or DL communication only, the modified interleaving procedure and/or frequency hopping procedure is used, or interleaving/frequency hopping is disabled, for all time domain resources in which communication using the frequency domain resources is to take place.

44. The method according to claim 38, wherein
in a case where communication using the frequency domain resources is to take place in both the at least one time domain resource with at least two frequency regions and at least one other time domain resource that is configured for UL or DL communication only, the modified interleaving procedure and/or frequency hopping procedure is used, or interleaving/frequency hopping is disabled, for the at least one time domain resource with at least two frequency regions in which communication using the frequency domain resources is to take place.

45. The method according to claim 38, further comprising:
in a case where communication using the frequency domain resources is to take place in both the at least one time domain resource with at least two frequency regions and at least one other time domain resource that is configured for UL or DL communication only, receiving, from the access network node, an indication of whether the modified interleaving procedure and/or frequency hopping procedure should be used, or interleaving/frequency hopping should be disabled:
for all time domain resources in which communication using the frequency domain resources is to take place; or
for only the at least one time domain resource with at least two frequency regions in which communication using the frequency domain resources is to take place.

46. The method according to claim 37, wherein
the mobile device is scheduled for DL communication, or UL communication, with the access network node in a plurality of time resources including both the at least one time domain resource with the at least two frequency regions, and
at least one other time domain resource which is configured for DL communication only, or for UL communication only.

47. The method according to claim 46, further comprising:
performing the DL communication, or the UL communication, using the at least one set of resources for communication with the access network node in the at least one other time domain resource; and
discarding the at least one set of resources for the DL communication, or the UL communication, in the at least one time domain resource with the at least two frequency regions, to avoid overlap between the at least one DL frequency region and the UL communication or between the at least one UL frequency region and the DL communication.

48. The method according to claim 46, further comprising:
performing the DL communication, or the UL communication, using the at least one set of resources for communication with the access network node in the at least one other time domain resource; and
pre-empting, cancelling, or rate-matching around a part of the at least one set of resources in the at least one time domain resource with the at least two frequency regions, to avoid overlap between the at least one DL frequency region and the UL communication or between the at least one UL frequency region and the DL communication.

49. The method according to claim 46, further comprising:
performing the DL communication, or the UL communication, using the at least one set of resources for communication with the access network node in the at least one other time domain resource; and
performing the DL communication, or the UL communication, using at least one other set of resources for communication with the access network node in the at least one time domain resource with the at least two frequency regions, to avoid overlap between the at least one DL frequency region and the UL communication or between the at least one UL frequency region and the DL communication.

50. The method according to claim 49, further comprising:
determining the at least one other set of resources based on a pre-defined rule.

51. The method according to claim 46, further comprising:
receiving from the access network node third information indicating whether the DL communication is permitted in the at least one DL frequency region of the at least one time domain resource with the at least two frequency regions, or whether the UL communication is permitted in the at least one UL frequency region of the at least one time domain resource with the at least two frequency regions.

52. The method according to claim 51, wherein
the third information includes information indicating a first set of radio resources for communication in the at least one time domain resource with the at least two frequency regions, and a second set of radio resources for communication in the at least one other time domain resource.

53. The method according to claim 51, wherein
the at least one time domain resource with at least two frequency regions includes a plurality of time domain resources with the at least two frequency regions, and
the third information includes information indicating a subset of the plurality time domain resources with the at least two frequency regions for which DL communication is permitted in at least one DL frequency region, or UL communication is permitted in at least one UL frequency region.

54. A method performed by an access network node, the method comprising:
transmitting, to a mobile device, first information for configuring at least one time domain resource with at least two frequency regions, wherein the at least two frequency regions include at least one downlink (DL) frequency region for DL communication and at least one uplink (UL) frequency region for UL communication; and
communicating with the mobile device, in the at least one time domain resource with at least two frequency regions, based on second information,
wherein the second information includes information for configuring frequency resources for at least one of:
at least one search space set;
at least one frequency resource set scheduled for DL communication to the mobile device;
at least one control resource set (CORESET); or
at least one frequency resource set scheduled for UL communication from the mobile device,
wherein the frequency domain resources are configured based on interleaving and/or frequency hopping, and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the mobile device; or
between the at least one DL frequency region and the at least one frequency resource set scheduled for UL communication from the mobile device.

55. A mobile device comprising:
at least one memory storing instructions; and
at least one processor configured to process the instructions to:
receive, from an access network node, first information for configuring at least one time domain resource with at least two frequency regions, wherein the at least two frequency regions include at least one downlink (DL) frequency region for DL communication and at least one uplink (UL) frequency region for UL communication;
communicate with the access network node, in the at least one time domain resource with at least two frequency regions, based on second information,
wherein the second information includes information for configuring frequency resources for at least one of:
at least one search space set;
at least one frequency resource set scheduled for DL communication from the access network node;
at least one control resource set (CORESET); or
at least one frequency resource set scheduled for UL communication to the access network node,
wherein the frequency domain resources are configured based on interleaving and/or frequency hopping, and the at least one processor is configured to process the instructions to:
determine, based on at least one of the first information and the second information, at least one set of resources for at least one of:
monitoring the at least one search space set;
DL communication in the at least one frequency resource set scheduled for DL communication;
monitoring the at least one CORESET; or
UL communication in the at least one frequency resource set scheduled for UL communication;
wherein, the at least one set of resources is determined by the mobile device to avoid, for the at least one time domain resource with at least two frequency regions, overlap:
between the at least one UL frequency region and at least one of:
the monitored at least one search space set;
the monitored at least one CORESET; or
the at least one frequency resource set used for the DL communication; or
between the at least one DL frequency region and the at least one frequency resource set used for the UL communication.

56. An access network node comprising:
at least one memory storing instructions; and
at least one processor configured to process the instructions to:
transmit, to a mobile device, first information for configuring at least one time domain resource with at least two frequency regions, wherein the at least two frequency regions include at least one downlink (DL) frequency region for DL communication and at least one uplink (UL) frequency region for UL communication; and
communicate with the mobile device, in the at least one time domain resource with at least two frequency regions, based on second information,
wherein the second information includes information for configuring frequency resources for at least one of:
at least one search space set;
at least one frequency resource set scheduled for DL communication to the mobile device;
at least one control resource set (CORESET); or
at least one frequency resource set scheduled for UL communication from the mobile device,
wherein the frequency domain resources are configured based on interleaving and/or frequency hopping, and
wherein, at least one of the first information and the second information is configured, for the at least one time domain resource with at least two frequency regions, to avoid overlap:
between the at least one UL frequency region and at least one of:
the at least one search space set;
the at least one CORESET; or
the at least one frequency resource set scheduled for DL communication to the mobile device; or
between the at least one DL frequency region and the at least one frequency resource set scheduled for UL communication from the mobile device.
